(19) United States
(12) Patent Application Publication
(10) Pub. No.: US 2025/0374154 A1
(43) Pub. Date: Dec. 4, 2025

(54) METHODS AND SYSTEMS FOR SELECTING A WIRELESS COMMUNICATION NETWORK FOR USE BY A MOVING USER EQUIPMENT DEVICE

(71) Applicant: Cable Television Laboratories, Inc., Louisville, CO (US)

(72) Inventors: Neeharika Jesukumar, Snoqualmie, WA (US); John C. Bahr, Superior, CO (US); Omkar Shripad Dharmadhikari, Centennial, CO (US)

(21) Appl. No.: 19/198,418

(22) Filed: May 5, 2025

Related U.S. Application Data
(60) Provisional application No. 63/655,948, filed on Jun. 4, 2024.

(51) Int. Cl. H04W 36/32; H04W 36/14

(52) U.S. Cl. CPC H04W 36/324; H04W 36/144

(57) ABSTRACT

A method for selecting a wireless communication network for use by a user equipment device that is moving includes (a) determining that the user equipment device is connected to each of a first wireless communication network and a second wireless communication network and (b) selecting, at least partially based on speed of movement of the user equipment device, one of the first wireless communication network and the second wireless communication network for use by the user equipment device for data transmission. The first wireless communication network is, for example, one of a community Wi-Fi wireless communication network and a community Third Generation Partnership Project (3GPP) wireless communication network. The second wireless communication network is, for example, one of a cellular wireless communication network and a satellite wireless communication network.

### RELATED APPLICATIONS

This application claims benefit of U.S. Provisional Patent Application No. 63/655,948, filed on Jun. 4, 2024, which is incorporated herein by reference.

### BACKGROUND

Two or more wireless communication networks may be available for use by a user equipment device at a given time. For example, a user equipment device may be connected to each of a community Wi-Fi wireless communication network and a cellular wireless communication network, and the user equipment device may therefore be able to use either of these two wireless communication networks for data transmission.

### SUMMARY

Disclosed herein are new methods and systems for selecting a wireless communication network for use by a moving user equipment device, which at least partially overcome one or more drawbacks of conventional network selection techniques. Certain embodiments are configured to consider speed of movement of a user equipment device when selecting an available wireless communication network for use by the user equipment device, such as to help select an available wireless communication network that offers a highest performance and/or lowest cost at the user equipment device's speed of movement. For example, some embodiments are configured to select an available community Wi-Fi wireless communication network over an available cellular wireless communication network for use by the user equipment device when the user equipment device is moving at a sufficiently slow speed that the community Wi-Fi wireless communication network can adequately serve the user equipment device. As another example, certain embodiments are configured to select an available cellular wireless communication network over an available community Wi-Fi wireless communication network for use by the user equipment device when the user equipment device is moving at a sufficiently fast speed such that the community Wi-Fi wireless communication network cannot adequately serve the user equipment device.

Additionally, particular embodiments are configured to consider geographic information, such as direction of user equipment device movement and/or geographic features in the vicinity of the user equipment device, when selecting a wireless communication network for use by the user equipment device. For example, some embodiments may (i) predict a future location of the user equipment device based on direction of movement, speed of movement, and/or presence of one or more geographic features near the user equipment device, (ii) identify wireless communication networks that are available for use by the user equipment device at the predicted future location, and (iii) limit selection of a wireless communication network to the wireless communication networks that are available for use by the user equipment device at the predicted future location.

Furthermore, some embodiments are configured to select radio frequency spectrum used by a wireless communication network when transmitting data associated with the user equipment device as a function of speed of movement of the user equipment device and/or as a function of geographic information, such as direction of movement of the user equipment device and/or presence of geographic features in the vicinity of the user equipment device. For example, certain embodiments may limit selection of radio frequency spectrum to radio frequency spectrum that is known to provide adequate wireless communication network coverage at the user equipment device's current location or predicted future location.

Moreover, some embodiments are configured to cause a user equipment device to connect to wireless access points or wireless base stations along a path of movement of the user equipment device according to a handoff pattern or a roaming pattern that is a function of speed of movement of the user equipment device and/or geographic information (e.g., direction of movement of the user equipment device and/or presence of geographic features in the vicinity of the user equipment device). For example, certain embodiments may cause the user equipment device to (i) connect to every community Wi-Fi wireless access point or every cellular wireless base station along a path of movement if a speed of movement of the user equipment device is below a particular threshold value and (ii) connect to every other community Wi-Fi wireless access point or every other cellular wireless base station along the path of movement if the speed of movement of the user equipment device is at least the particular threshold value.

In an embodiment, a method for selecting a wireless communication network for use by a user equipment device that is moving includes (a) determining that each of a community Wi-Fi wireless communication network and a cellular wireless communication network is available for use by the user equipment device, (b) determining that a speed of movement of the user equipment device does not exceed a threshold value, and (c) in response to determining that the speed of movement of the user equipment device does not exceed the threshold value, causing the user equipment device to use the community Wi-Fi wireless communication network, instead of the cellular wireless communication network, for data transmission.

In another embodiment, a method for selecting a wireless communication network for use by a user equipment device that is moving includes (a) determining that each of a community Wi-Fi wireless communication network and a cellular wireless communication network is available for use by the user equipment device, (b) determining that a speed of movement of the user equipment device is at least a threshold value, and (c) in response to determining that the speed of movement of the user equipment device is at least the threshold value, causing the user equipment device to use the cellular wireless communication network, instead of the community Wi-Fi wireless communication network, for data transmission.

In another embodiment, a method for selecting a wireless communication network for use by a user equipment device that is moving includes (a) determining that the user equipment device is connected to each of a first wireless communication network and a second wireless communication network and (b) selecting, at least partially based on speed of movement of the user equipment device, one of the first wireless communication network and the second wireless communication network for use by the user equipment device for data transmission.

### BRIEF DESCRIPTION OF THE DRAWINGS

FIG. 1 is a schematic diagram of a communication environment including a system for selecting a wireless communication network for use by a moving user equipment device, according to an embodiment.

FIG. 2 illustrates a user equipment device of the FIG. 1 communication environment in further detail than in FIG. 1.

FIG. 3 is a flowchart of a method for selecting a wireless communication network for use by a moving user equipment device, according to an embodiment.

FIG. 4 is a schematic diagram of an embodiment of the FIG. 1 communication environment including a plurality of community Wi-Fi wireless access points with overlapping coverage areas.

FIG. 5 is a schematic diagram illustrating a handoff pattern where a user equipment device connects to every community Wi-Fi wireless access point along its path of movement.

FIG. 6 is a schematic diagram illustrating a handoff pattern where a user equipment device connects to every other community Wi-Fi wireless access point along its path of movement.

FIG. 7 is a schematic diagram illustrating a connection pattern where a user equipment device connects to every third community Wi-Fi wireless access point along its path of movement.

FIG. 8 is a flow chart of a method for selecting a handoff pattern, according to an embodiment.

FIG. 9 is a flowchart of another method for selecting a wireless communication network for use by a moving user equipment device, according to an embodiment.

FIG. 10 is a schematic diagram illustrating a roaming pattern where a user equipment device connects to every cellular wireless base station along its path of movement.

FIG. 11 is a schematic diagram illustrating a roaming pattern where a user equipment device connects to every other cellular wireless base station along its path of movement.

FIG. 12 is a flow chart of a method for selecting a roaming pattern, according to an embodiment.

FIG. 13 is a flow chart of an alternate embodiment of the FIG. 3 method implementing only a single speed classification step.

FIGS. 14A and 14B are collectively a flowchart of a method for selecting a wireless communication network for use by a moving user equipment device that considers each of geographic data and speed of user equipment device movement when selecting the wireless communication network, according to an embodiment.

FIG. 15 is a schematic diagram of an embodiment of the FIG. 1 communication environment including sixteen community Wi-Fi wireless access points and a bicycle path.

FIG. 16 is a schematic diagram of an embodiment of the FIG. 1 communication environment including nine cellular wireless base stations and a road.

FIG. 17 is a schematic diagram of an embodiment of the FIG. 1 communication environment including a building and a walkway.

FIG. 18 is a schematic diagram of an alternate embodiment of the FIG. 1 communication environment including a satellite wireless communication network in place of a cellular wireless communication network.

FIG. 19 is a schematic diagram of an alternate embodiment of the FIG. 1 communication environment including a community Third Generation Partnership Project (3GPP) wireless communication network in place of a community Wi-Fi wireless communication network.

### DEFINITIONS

The following are definitions of terms used in this document:
(a) Wireless communication network: a communication network that is capable of transmitting data between user equipment devices and one or more network resources (e.g., the Internet, an intranet, a content delivery network, and/or a data storage network) at least partially using radio frequency wireless signals.
(b) User equipment device: an information technology device that is capable of using a wireless communication network for data transmission. By way of example and not limitation, a user equipment device may be one of a mobile phone, a personal computer, a wearable information technology device (e.g., a smart watch, smart glasses, a smart ring, a wearable medical device, a wearable fitness tracker, etc.), an entertainment device, a security device, a home automation device, a set top box, a data storage device, and an Internet of Things (IoT) device.
(c) Private Wi-Fi wireless communication network: a wireless communication network operating according to an Institute of Electrical and Electronics Engineers (IEEE) 802.11 standard, or a successor thereof, that is associated with a single premises, such as a single home or a single business.
(d) Community Wi-Fi wireless communication network: a wireless communication network operating according to an IEEE 802.11 standard, or a successor thereof, that includes a plurality of community Wi-Fi wireless access points at different respective premises, such as a plurality of community Wi-Fi wireless access points at different respective homes and/or at different respective businesses. Community Wi-Fi wireless access points of a community Wi-Fi wireless communication network optionally share a common Service Set Identifier (SSID) and/or other wireless communication network identifier. While not required, a community Wi-Fi wireless communication network may be operated by a multiple system operator (MSO), such as a cable company.
(e) Community 3GPP wireless communication network: a wireless communication network that operates according to a Third Generation Partnership (3GPP) standard or a successor therefore and includes a plurality of community 3GPP wireless access points at different respective premises, such as a plurality of community 3GPP wireless access points at different respective homes and/or at different respective businesses. While not required, a community 3GPP wireless communication network may operate in Citizen's Broadband Radio Service (CBRS) radio frequency spectrum. By way of example and not limitation, a community 3GPP wireless communication network may operate according to a long term evolution (LTE) 3GPP standard, a fifth generation (5G) 3GPP standard, a sixth generation (6G) 3GPP standard, or a successor thereof. While not required, a community 3GPP wireless communication network may be operated by a MSO, such as a cable company.
(f) Cellular wireless communication network: a wireless communication network operating according to a 3GPP standard or a successor therefore. By way of example and not limitation, a cellular wireless communication network may operate according to an LTE 3GPP standard, a 5G 3GPP standard, a 6G 3GPP standard, or a successor thereof. While not required, a cellular wireless communication network may be operated by a mobile network operator (MNO), such as a cellular wireless carrier. A cellular wireless communication network may be a public land mobile network (PLMN), a standalone non-public network (SNPN), or a combination of a public network and a non-public network, such as a public network integrated with a non-public network (PNI-NPN).
(g) Satellite wireless communication network: a wireless communication network using one or more satellites, such as very low earth orbit (VLEO) satellites, low earth orbit (LEO) satellites, medium earth orbit (MEO) satellites, or geostationary equatorial orbit (GEO) satellites, as communication signal relay devices between one or more communication ground stations and one or more user equipment devices.

### DETAILED DESCRIPTION OF THE EMBODIMENTS

As discussed above, two or more wireless communication networks may be available for use by a user equipment device at a given time. For example, a user device may be connected to both a community Wi-Fi wireless communication network and a cellular wireless communication network, and the user equipment device could therefore use either of these two wireless communication networks for data transmission. Accordingly, a user equipment device may need to select one of two or more available wireless communication networks to use for data transmission. A user equipment device conventionally selects an available wireless communication network for use according to a proprietary algorithm implemented by its operating system, where the algorithm is at least partially based on received signal strength indicators (RSSIs) of available wireless communication networks. Conventional wireless communication network selection techniques, though, may result in a sub-optimum wireless communication network selection, particularly if the user equipment device is moving. For example, a user equipment device employing conventional wireless communication network selection techniques may be undesirably “sticky,” i.e., it may remain connected to a wireless communication network while moving out of range of the wireless communication network. As another example, a user equipment device using conventional wireless communication network selection techniques may incur unnecessary communication costs by selecting a high-cost available wireless communication network to use for data transmission over a low-cost available wireless communication network.

Disclosed herein are new methods and systems for selecting a wireless communication network for use by a moving user equipment device, which at least partially overcome one or more drawbacks of conventional network selection techniques. Certain embodiments are configured to consider speed of movement of a user equipment device when selecting an available wireless communication network for use by the user equipment device, such as to help select an available wireless communication network that offers a highest performance and/or lowest cost at the user equipment device's speed of movement. For example, some embodiments are configured to select an available community Wi-Fi wireless communication network over an available cellular wireless communication network for use by the user equipment device when the user equipment device is moving at a sufficiently slow speed that the community Wi-Fi wireless communication network can adequately serve the user equipment device. As another example, certain embodiments are configured to select an available cellular wireless communication network over an available community Wi-Fi wireless communication network for use by the user equipment device when the user equipment device is moving at a sufficiently fast speed such that the community Wi-Fi wireless communication network cannot adequately serve the user equipment device.

Additionally, particular embodiments are configured to consider geographic information, such as direction of user equipment device movement and/or geographic features in the vicinity of the user equipment device, when selecting a wireless communication network for use by the user equipment device. For example, some embodiments may (i) predict a future location of the user equipment device based on direction of movement, speed of movement, and/or presence of one or more geographic features near the user equipment device, (ii) identify wireless communication networks that are available for use by the user equipment device at the predicted future location, and (iii) limit selection of a wireless communication network to the wireless communication networks that are available for use by the user equipment device at the predicted future location.

Furthermore, some embodiments are configured to select radio frequency spectrum used by a wireless communication network when transmitting data associated with the user equipment device as a function of speed of movement of the user equipment device and/or as a function of geographic information, such as direction of movement of the user equipment device and/or presence of geographic features in the vicinity of the user equipment device. For example, certain embodiments may limit selection of radio frequency spectrum to radio frequency spectrum that is known to provide adequate wireless communication network coverage at the user equipment device's current location or predicted future location.

Moreover, some embodiments are configured to cause a user equipment device to connect to wireless access points or wireless base stations along a path of movement of the user equipment device according to a handoff pattern or a roaming pattern that is a function of speed of movement of the user equipment device and/or geographic information (e.g., direction of movement of the user equipment device and/or presence of geographic features in the vicinity of the user equipment device). For example, certain embodiments may cause the user equipment device to (i) connect to every community Wi-Fi wireless access point or every cellular wireless base station along a path of movement if a speed of movement of the user equipment device is below a particular threshold value and (ii) connect to every other community Wi-Fi wireless access point or every other cellular wireless base station along the path of movement if the speed of movement of the user equipment device is at least the particular threshold value.

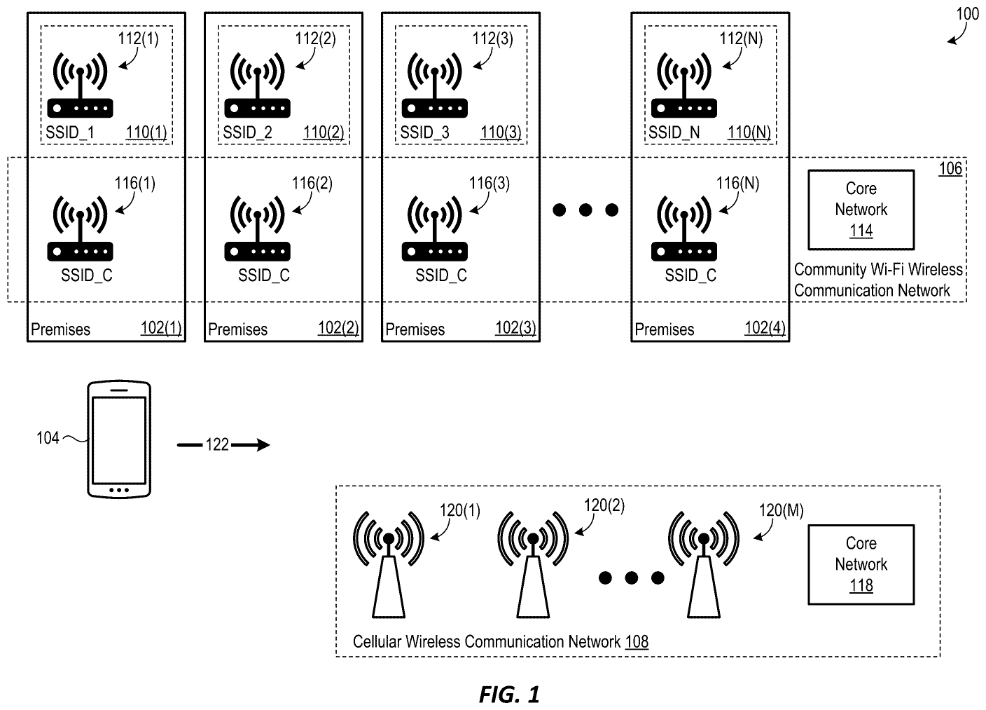

FIG. 1 is a schematic diagram of a communication environment 100 that includes a system for selecting a wireless communication network for use by a moving user equipment device. Communication environment 100 includes N premises 102, a user equipment device 104, a community Wi-Fi wireless communication network 106, and a cellular wireless communication network 108, where N is an integer greater than one. In this document, specific instances of an item may be referred to by use of a numeral in parentheses (e.g. premises 102(1)) while numerals without parentheses refer to any such item (e.g. premises 102). Each premises 102 is, for example, a home or a business. Although FIG. 1 depicts N being greater than three, N could alternately be equal to two or three without departing from the scope hereof. Additionally, while FIG. 1 illustrates premises 102 as being located in a row, e.g., along a road (not shown), premises 102 can be distributed in another manner. For example, in some embodiments, premises 102 are distributed over a neighborhood, over multiple neighborhoods, over a section of a city, or even over an entire city or metropolitan area. Furthermore, while FIG. 1 only depicts a single user equipment device for illustrative simplicity, communication environment 100 can (and typically will) include multiple user equipment devices.

Each premises 102 includes a respective private Wi-Fi wireless communication network 110, and each private Wi-Fi wireless communication network 110 includes at least one private Wi-Fi wireless access point 112. Each private Wi-Fi wireless communication network 110 is configured to serve to user equipment devices, i.e., to provide data transmission service for user equipment devices, that are associated with its respective premises 102. For example, private Wi-Fi wireless communication network 110(1) may be configured to serve user equipment devices owned by a party associated with premises 102(1), private Wi-Fi wireless communication network 110(2) may be configured to serve user equipment devices owned by a party associated with premises 102(2), as so on. While not required, it is anticipated that each private Wi-Fi wireless communication network 110 will typically be identified by a different respective service set identifier (SSID). For example, FIG. 1 illustrates private Wi-Fi wireless communication network 110(1) being identified by SSID_1, private Wi-Fi wireless communication network 110(2) being identified by SSID_2, and so on.

Community Wi-Fi wireless communication network 106 includes a core network 114 and a plurality of community Wi-Fi wireless access points 116. While FIG. 1 illustrates each premises 102 including one community Wi-Fi wireless access point 116, community Wi-Fi wireless access points 116 could be distributed among premises 102 in a different manner, as long as community Wi-Fi wireless access points 116 are distributed among multiple premises 102. For example, some premises 102 could include two or more community Wi-Fi wireless access points 116 while some other premises 102 might not include any community Wi-Fi wireless access points 116. Core network 114 at least partially controls operation of community Wi-Fi wireless access points 116, such as to coordinate handoff of a user equipment device between two community Wi-Fi wireless access points 116 and/or to coordinate radio frequency spectrum use among community Wi-Fi wireless access points 116. While core network 114 is illustrated as being a discrete element, core network 114 may be partially or fully combined with another element. Additionally, in some alternate embodiments, core network 114 is omitted and functionality of core network 114 is instead implemented by one or more community Wi-Fi wireless access points 116.

Community Wi-Fi wireless communication network 106 may be capable of serving user equipment devices, i.e., providing data transmission services for user equipment devices, over a large area due to the presence of community Wi-Fi wireless access points 116 in multiple premises 102. For example, in some embodiments, community wireless communication network 106 can serve user equipment devices over multiple blocks, over multiple neighborhoods, or even over a large portion of a city or other geographic area. While not required, it is anticipated that community Wi-Fi wireless access points 116 will typically share a common SSID. For example, FIG. 1 illustrates each community Wi-Fi wireless access point 116 being identified by a common SSID_C. As such, community Wi-Fi wireless access points 116 may collectively form a single logical communication network that potentially covers a large area.

Although private Wi-Fi wireless access points 112 and community Wi-Fi wireless access points 116 are illustrated as being separate elements, in certain embodiments, a private Wi-Fi wireless access point 112 and a community Wi-Fi wireless access point 116 of a given premises 102 may share some or more elements. For example, in some embodiments, private Wi-Fi wireless access point 112(1) and community Wi-Fi wireless access point 116(1) are part of a common premises gateway (not shown) in premises 102(1). In these embodiments, private Wi-Fi wireless access point 112(1) and community Wi-Fi wireless access point 116(1) may share one or more elements. For example, private Wi-Fi wireless access point 112(1) and community Wi-Fi wireless access point 116(1) may share an access network termination device (e.g., a modem or an optical network termination), an antenna, and/or transceiver, such as by using a time division multiplexing technique and/or a frequency division multiplexing technique. Private Wi-Fi wireless access points 112 and community Wi-Fi wireless access points 116 of other premises 102 could be combined in a similar manner.

Cellular wireless communication network 108 includes a core network 118 and M cellular wireless base stations 120, where M is an integer greater than one. Each cellular wireless base station 120 is, for example, a macro cell or a small cell. While cellular wireless base stations 120 are illustrated as being disposed in a row for illustrative simplicity, it is anticipated that cellular wireless base stations 120 will be typically be spread over a large geographic area to form a radio access network (RAN) that is capable of serving user equipment devices, i.e., providing data transmission services for user equipment devices, over the large geographic area. Core network 118 controls, for example, user plane functions and control plane functions of cellular wireless communication network 108. In some embodiments, core network 118 includes one or more of a 3GPP evolved packet core, a 3GPP 5G core network, and/or a 3GPP 6G core network.

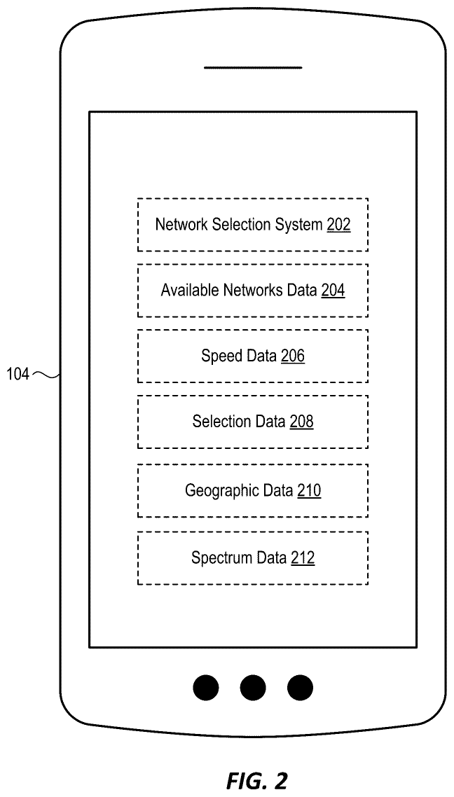

FIG. 2 illustrates user equipment device 104 in further detail. User equipment device 104 includes a network selection system 202, which is one embodiment of the new systems for selecting a wireless communication network for use by a moving user equipment device. User equipment device 104 also includes available networks data 204, speed data 206, selection data 208, geographic data 210, and spectrum data 212. Geographic data 210 and spectrum data 212 are optional, and in some embodiments, one or both of geographic data 210 and spectrum data 212 are omitted. Network selection system 202 is implemented by electronic circuitry of user equipment device 104. For example, in some embodiments, network selection system 202 is at least partially implemented by a processor of user equipment device 104 executing instructions (e.g., software and/or firmware) stored in a data store (e.g., memory and/or data storage drive) of user equipment device 104. Each of speed data 206, selection data 208, geographic data 210 (when present), and spectrum data 212 (when present) is stored in the data store of user equipment device 104.

Although network selection system 202 is part of user equipment device 104 in communication environment 100, network selection system 202 may interact with other elements of communication environment 100, such as community Wi-Fi wireless communication network 106 and/or cellular wireless communication network 108. In some alternate embodiments, network selection system 202 is distributed across two or more elements of communication environment 100 instead of being fully implemented by user equipment device 104. For example, in some alternate embodiments, network selection system 202 is distributed between user equipment device 104 and one or more of community Wi-Fi wireless communication network 106 and cellular wireless communication network 108. Additionally, in some other alternate embodiments, network selection system 202 is separate from user equipment device 104. For example, in certain alternate embodiments, network selection system 202 is implemented by one or more of community Wi-Fi wireless communication network 106, cellular wireless communication network 108, and/or a remote computing environment (not shown, e.g., a cloud computing environment).

Network selection system 202 is configured to determine available networks data 204, which identifies wireless communication networks that are available for use by user equipment device 104 for data transmission. For example, if user equipment device 104 is currently connected to each of community Wi-Fi wireless communication network 106 and cellular wireless communication network 108, available networks data 204 identifies these two wireless communication networks as wireless communication networks available for use by user equipment device 104. User equipment device 104 need not be connected to a given wireless communication network for the wireless communication network to be considered available for use by user equipment device 104 if user equipment device 104 can readily connect to the wireless communication network. Network selection system 202 determines available networks data 204, for example, from connection data generated by user equipment device 104 and/or from wireless communication network beacons, or other data structures, received by user equipment device 104.

Network selection system 202 is further configured to determine speed data 206, which represents a speed of movement 122 (FIG. 1) of user equipment device 104, such as in meters per second, feet per second, kilometers per hour, miles per hour, etc. Alternately or additionally, speed data 206 may classify a speed of movement of user equipment device 104, e.g., that user equipment device 104 is moving at a high speed, a medium speed, or a low speed, or that user equipment device 104 is moving at a walking speed, a running speed, a biking speed, or a driving speed. Network selection system 202 determines speed data 206, for example, from accelerometer data of user equipment device 104, global positioning system (GPS) data from user equipment device 104, and/or data received from one or more of wireless communication network 106 and cellular wireless communication network 108, such as triangulation data from community Wi-Fi wireless communication network 106 and/or cellular wireless communication network 108 identifying past and/or present locations of user equipment device 104.

Network selection system 202 is optionally further configured to determine one or more of geographic data 210 and spectrum data 212. Geographic data 210 includes, for example, direction data indicating a direction of movement 122 of user equipment device 104, such as a compass direction (north, east, west, or south) or a relative direction (e.g., towards a particular reference point or away from the reference point). Network selection system 202 determines direction data, for example, from GPS data from user equipment device 104 and/or from data received from one or more of wireless communication network 106 and cellular wireless communication network 108. Geographic data 210 may alternately or additionally indicate presence of geographic features in the vicinity of user equipment device 104, such as presence of a sidewalk, a bike path, a road, or a building. Furthermore, geographic data 210 may include locations of community Wi-Fi wireless access points 116 and/or locations of cellular wireless base stations 120. In some embodiments, network selection system 202 determines presence of geographic features, locations of community Wi-Fi wireless access points 116, and/or locations of cellular wireless base stations 120, for example, by accessing a mapping database or other database.

Spectrum data 212 identifies radio frequency spectrum ranges available for use by wireless communication networks identified by available network data 204 when wirelessly communicating with user equipment device 104. For example, in embodiments where cellular wireless communication network 108 is capable of operating in each of advanced wireless services (AWS) radio frequency spectrum, C-band radio frequency spectrum, and millimeter wavelength radio frequency spectrum, spectrum data 216 indicates that each of AWS, C-band, and millimeter wavelength radio frequency spectrum is available for use by cellular wireless communication network 108 when wirelessly communicating with user equipment device 104. As another example, in embodiments where community Wi-Fi wireless communication network 106 is capable of operating in 2.4 gigahertz (GHz), 5 GHz, and 6 GHz radio frequency spectrum, spectrum data 212 indicates that each of 2.4 GHz, 5 GHz, and 6 GHz radio frequency spectrum is available for use by community Wi-Fi wireless communication network 106 when wirelessly communicating with user equipment device 104. Network selection system 202 determines spectrum data 212, from example, by accessing a database listing radio spectrum available for use by various wireless communication networks.

Network selection system 202 is additionally configured to (i) select one of the available wireless communication networks, as identified by available networks data 204, for use by user equipment device 104 for data transmission, and (ii) generate selection data 208 identifying the selected wireless communication network. User equipment device 104 then uses the wireless communication network identified by selection data 208 for wireless data transmission. For example, assume that network selection system 202 selects community Wi-Fi wireless communication network 106 and generates selection data 208 identifying community Wi-Fi wireless communication network 106 as the selected wireless communication network. User equipment device 104 would then use community Wi-Fi wireless communication network 106 for data transmission, such as by connecting to community Wi-Fi wireless communication network 106 or by activating an existing idle connection to community Wi-Fi wireless communication network 106. As another example, assume that network selection system 202 selects cellular wireless communication network 108 and generates selection data 208 identifying cellular wireless communication network 108 as the selected wireless communication network. User equipment device 104 would then use cellular wireless communication network 108 for data transmission, such as by connecting to cellular wireless communication network 108 or by activating an existing idle connection to cellular wireless communication network 108.

Network selection system 202 is configured to select an available wireless communication network for use by user equipment device 104 for data transmission at least partially based on speed of movement of user equipment device 104, as identified by speed data 206. In some embodiments, network selection system 202 is further configured to select an available wireless communication network for use by user equipment device 104 for data transmission based on geographic data 210 (e.g., speed of movement of user equipment device 104 and/or presence of one or more geographic features in the vicinity of user equipment device 104). For example, some embodiments of network selection system 202 are configured to (i) predict a future location of user equipment device 104 based on speed data 206 and geographic data 210, (ii) identify wireless communication networks that are available for use by user equipment device 104 at the predicted future location, and (iii) limit selection of a wireless communication network to the wireless communication networks that are available for use by user equipment device 104 at the predicted future location.

Additionally, in particular embodiments, network selection system 202 is further configured to select, from spectrum data 212, radio frequency spectrum for use by the selected wireless communication network when communicating with user equipment device 104 based on one or more of geographic data 210 and speed data 206. For example, certain embodiments of network selection system 202 are configured to limit selection of radio frequency spectrum to radio frequency spectrum that is known to provide adequate wireless communication network coverage at user equipment device 104's current location or at a predicted future location of user equipment device 104.

Discussed below are several example methods of operation of network selection system 202. However, network selection system 202 is not limited to operating according to these example methods. Additionally, the example methods discussed below could be implemented by network selection systems other than network selection system 202.

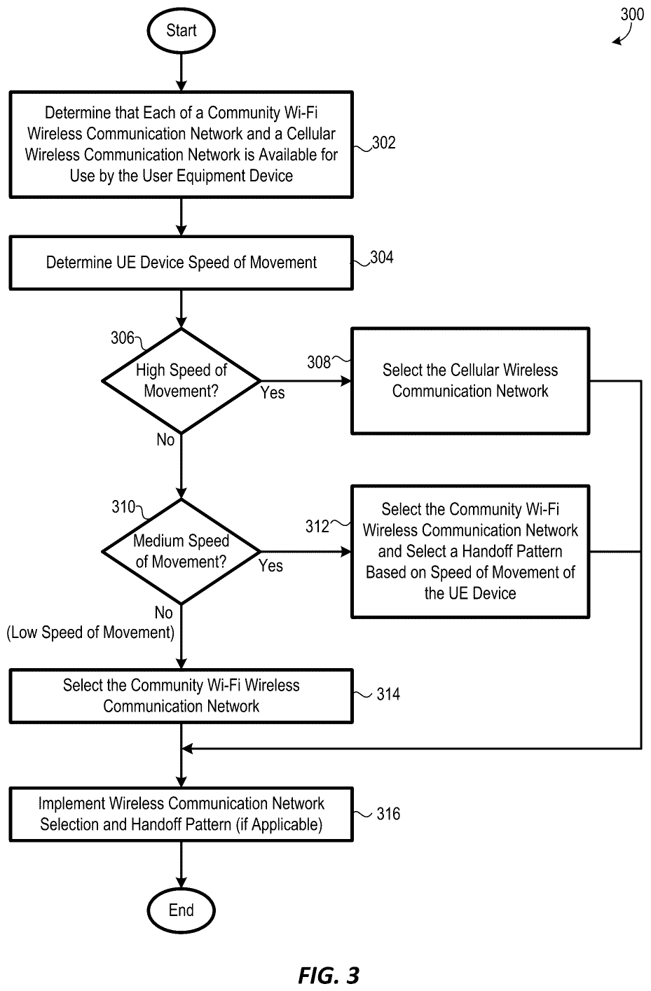

FIG. 3 is a flowchart of a method 300 for selecting a wireless communication network for use by a moving user equipment device, which is one embodiment of the new methods disclosed herein. Method 300 assumes that (i) user equipment device 104 was previously connected to a private Wi-Fi wireless communication network 110, (ii) user equipment device moved out of the range of the private Wi-Fi wireless communication network 110, (iii) as result of user equipment device 104 moving out of range of the private Wi-Fi wireless communication network 110, user equipment device 104 is caused to disconnect from the private Wi-Fi wireless communication network 110 and connect to community Wi-Fi wireless communication network 106, and (iv) user equipment device 104 is also connected to cellular wireless communication network 108. As such, community Wi-Fi wireless communication network 106 and cellular wireless communication network 108 are each available for use by user equipment device 104 at the beginning of execution of method 300. Method 300 is one example of how network selection system 202 may select between these two wireless communication networks for use by user equipment device 104.

In a block 302 of method 300, network selection system 202 determines that each of community Wi-Fi wireless communication network 106 and cellular wireless communication network 108 is available for use by user equipment device 104. In one example of block 302, network selection system 202 (i) determines from connection data of user equipment device 104 that user equipment device 104 is connected to each of community Wi-Fi wireless communication network 106 and cellular wireless communication network 108, (ii) determines that each of community Wi-Fi wireless communication network 106 and cellular wireless communication network 108 are available for use by user equipment device 104 for data transmission in view of user equipment device 104 being connected to each of these wireless communication networks, and (iii) generates available networks data 204 identifying community Wi-Fi wireless communication network 106 and cellular wireless communication network 108.

Method 300 proceeds from block 302 to a block 304 where network selection system 202 determines speed of movement 122 of user equipment device 104. In one example of block 304, (i) network selection system 202 determines at least partially from GPS data of user equipment device 104 that speed of movement of user equipment device 104 is one meter per second and (ii) network selection system 202 generates speed data 206 indicating that speed of movement 122 of user equipment device 104 is one meter per second.

Method 300 proceeds from block 304 to a decision block 306 and determines whether speed of movement 122 of user equipment device 104 is classified as high speed. In one example of decision block 306, network selection system 202 compares speed data 206 to a threshold value representing a minimum speed for movement 122 of user equipment device 104 to be considered high speed. If the result of decision block 306 is yes, method 300 proceeds from decision block 306 to a block 308 where network selection system 202 selects cellular wireless communication network 108 for use by user equipment device 104 for data transmission. It is advantageous to select cellular wireless communication network 108 over community Wi-Fi wireless communication network 106 when user equipment device 104 is moving at a high speed because (i) user equipment device 104 would likely have to quickly switch from using community Wi-Fi wireless communication network 106 to using cellular wireless communication network 108 due to user equipment device 104 quickly moving out of a coverage area of community Wi-Fi wireless communication network 106, and (ii) user equipment device 104 may experience communication downtime while switching from using community Wi-Fi wireless communication network 106 to using cellular wireless communication network 108. In one example of block 308, network selection system 202 generates selection data 208 identifying cellular wireless communication network 108 as the wireless communication network selected for use by user equipment device 104, in response to the result of decision block 306 being yes.

If the result of decision block 306 is no, method 300 proceeds from decision block 306 to a decision block 310 and determines whether speed of movement 122 of user equipment device 104 is classified as medium speed. In one example of decision block 310, network selection system 202 compares speed data 206 to a threshold value representing a minimum speed for movement 122 of user equipment device 104 to be considered medium speed. If the result of decision block 310 is yes, method 300 proceeds from decision block 310 to a block 312 where community Wi-Fi wireless communication network 106 is selected for use by user equipment device 104 for data transmission. In one example of block 312, network selection system 202 generates selection data 208 identifying community Wi-Fi wireless communication network 106 as the wireless communication network selected for use by user equipment device 104, in response to the result of decision block 310 being yes. It is typically advantageous for user equipment device 104 to use community Wi-Fi wireless communication network 106 instead of cellular wireless communication network 108 when user equipment device 104's speed of movement is classified as medium because (i) community Wi-Fi wireless communication network 106 is typically capable of adequately serving using equipment device 104 when it is moving at a medium speed and (ii) community Wi-Fi wireless communication network 106 typically has a lower use cost than cellular wireless communication network 108.

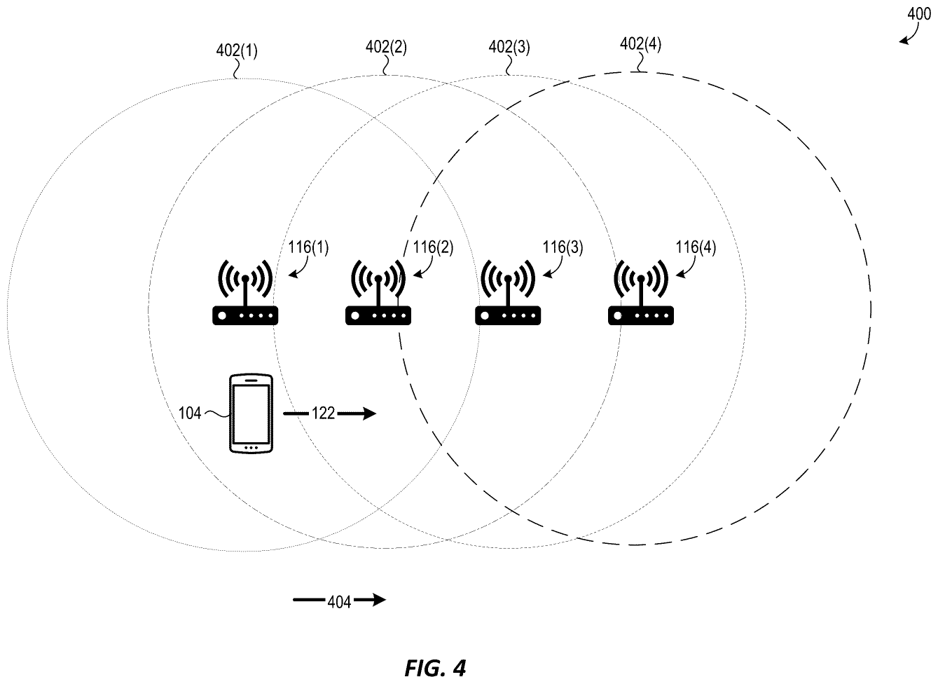

Additionally, Applicant has determined that it may be advantageous for user equipment device 104 to connect to only a subset of community Wi-Fi wireless access points 116 along a path of movement of user equipment device 104 when speed of movement of user equipment device 104 is classified as medium, such as when a person carrying user equipment device 104 is walking quickly, running, or biking. In particular, community Wi-Fi wireless access points 116 typically have overlapping coverage areas along a path of movement 122 of user equipment device 104 such that it is not necessary for user equipment device 104 to connect to every community Wi-Fi wireless access point 116 along its path of movement 122. For example, FIG. 4 is a schematic diagram of a communication environment 400, which is one embodiment of communication environment 100 including four community Wi-Fi wireless access points 116. While only community Wi-Fi wireless access points 116 and user equipment device 104 are shown in FIG. 4 for illustrative clarity, it is understood that the other elements of communication environment 100 are present in communication environment 400. Each community Wi-Fi wireless access point 116 has a respective coverage area 402. Specifically, community Wi-Fi wireless access point 116(1) has a coverage area 402(1), community Wi-Fi wireless access point 116(2) has a coverage area 402(2), and so on. Although coverage areas 402 are shown as circles for illustrative simplicity, shapes of coverage areas 402 may vary.

As illustrated in FIG. 4, coverage areas 402 of community Wi-Fi wireless access points 116 significantly overlap in communication environment 400. As such, it is not necessary for user equipment device 104 to connect to every community Wi-Fi wireless access point 116 along its path of movement 122 for user equipment device 104 to be adequately served by community Wi-Fi wireless communication network 106. For example, user equipment device 104 could skip connecting to community Wi-Fi wireless access point 116(2) while moving 122 in a direction 404 and remain within coverage areas 402 of community Wi-Fi wireless access points 116, due to overlapping coverage areas 402 of community Wi-Fi wireless access points 116. Additionally, it is desirable to minimize handoff of user equipment device 104 between community Wi-Fi wireless access points 116 because (i) communication between user equipment device 104 and community Wi-Fi wireless communication network 106 may be interrupted during a handoff and (ii) each handoff consumes resources of community Wi-Fi wireless communication network 106.

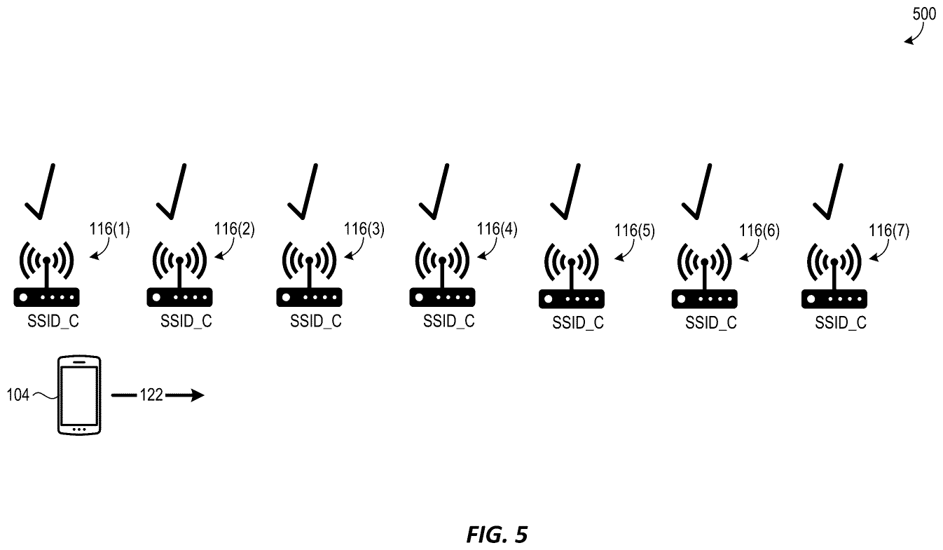

Accordingly, block 312 further includes the step of network selection system 202 selecting a handoff pattern of user equipment device 104 as a function of speed of movement 122 of user equipment device 104, as represented by speed data 206, to help minimize unnecessary handoffs of user equipment device 104 between community Wi-Fi wireless access points 116. The handoff pattern specifies which community Wi-Fi wireless access points 116 that user equipment device 104 connects to along its path of movement 122. A handoff pattern may specify, for example, that user equipment device 104 connects to every community Wi-Fi wireless access point 116 along its path of movement or that user equipment device 104 connects to only a subset of community Wi-Fi wireless access points 116 along its path of movement. FIGS. 5-7, discussed below, illustrate several example handoff patterns that network selection system 202 could select in block 312. However, it is understood that network selection system 202 may select other handoff patterns in block 312. Additionally, while FIGS. 5-7 illustrate embodiments where there are seven community Wi-Fi wireless access points 116, it is understood that the quantity of community Wi-Fi wireless access points 116 may vary.

FIG. 5 is a schematic diagram illustrating a handoff pattern 500 where user equipment device 104 connects to every community Wi-Fi wireless access point 116 along its path of movement. Community Wi-Fi wireless access points 116 that user equipment device 104 connects to are labeled with a check mark, and user equipment device 104 accordingly connects to community Wi-Fi wireless access points 116(1), 116(2), 116(3), 116(4), 116(5), 116(6), and 116(7) along its path of movement 122, in handoff pattern 500.

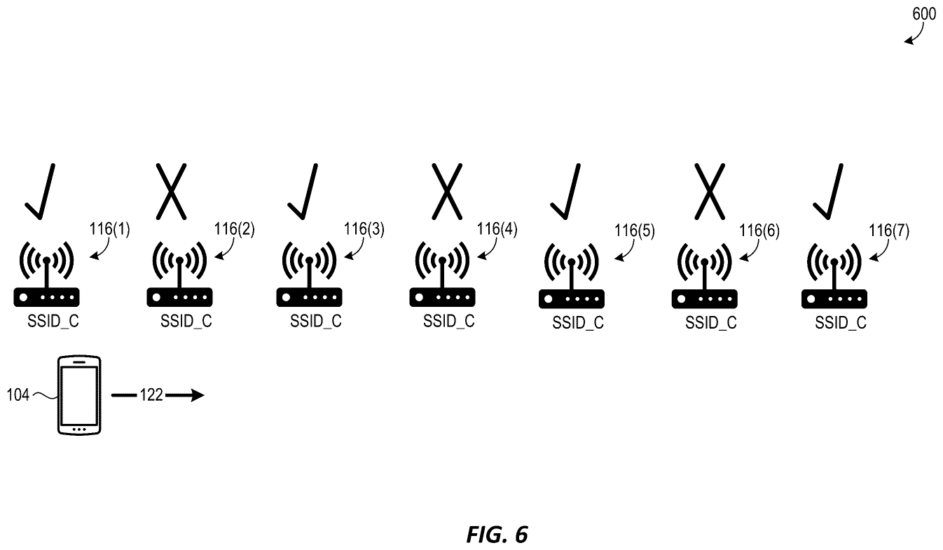

FIG. 6 is a schematic diagram illustrating a handoff pattern 600 where user equipment device 104 connects to every other community Wi-Fi wireless access point 116 along its path of movement. Community Wi-Fi wireless access points 116 that user equipment device 104 connects to are labeled with a check mark while community Wi-Fi wireless access points 116 that user equipment device 104 does not connect to are labeled with the letter “X.” Accordingly, user equipment device 104 connects to community Wi-Fi wireless access points 116(1), 116(3), 116(5), and 116(7) along its path of movement 122, and user equipment device 104 does not connect to community Wi-Fi wireless access points 116(2), 116(4), and 116(6) along its path of movement 122, in handoff pattern 600.

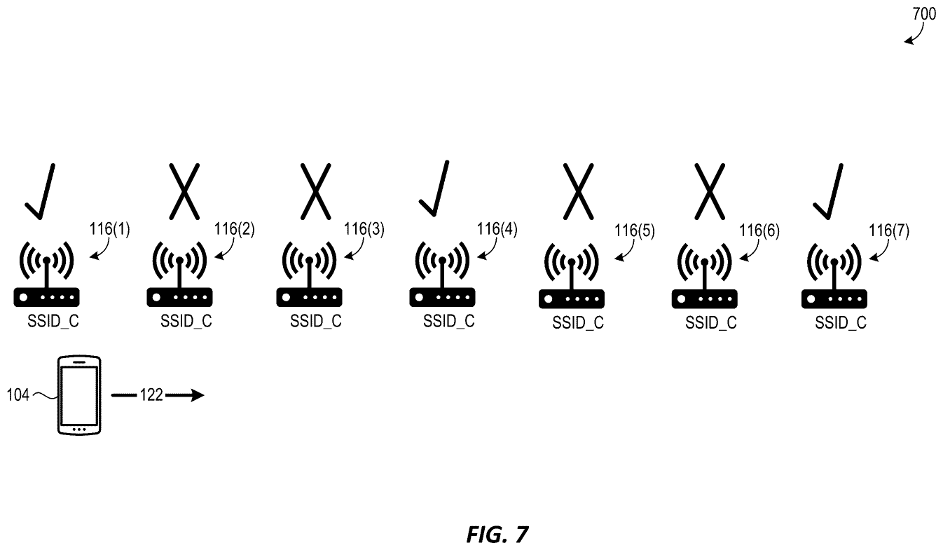

FIG. 7 is a schematic diagram illustrating a handoff pattern 700 where user equipment device 104 connects to every third community Wi-Fi wireless access point 116 along its path of movement. Analogous to FIG. 6, community Wi-Fi wireless access points 116 that user equipment device 104 connects to are labeled with a check mark while community W-Fi wireless access points 116 that user equipment device 104 does not connect to are labeled with the letter “X.” Accordingly, user equipment device 104 connects to community Wi-Fi wireless access points 116(1), 116(4), and 116(7) along its path of movement 122, and user equipment device 104 does not connect to community Wi-Fi wireless access points 116(2), 116(3), 116(5), and 116(6) along its path of movement 122, in handoff pattern 700.

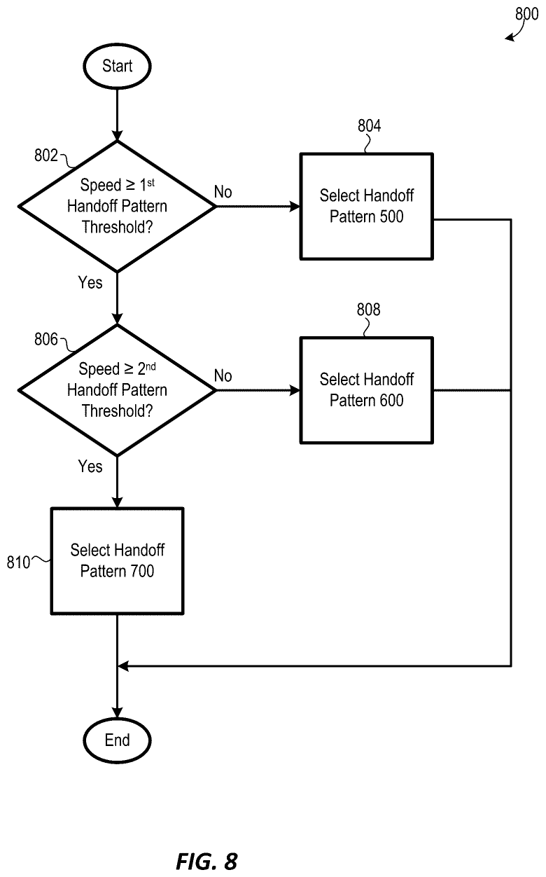

Referring again to FIG. 3, in some embodiments, network selection system 202 selects a handoff pattern such that quantity of community Wi-Fi wireless access points 116 that user equipment device 104 connects to decreases with increasing speed of movement 122 of user equipment device 104. For example, FIG. 8 is a flow chart of a method 800 for selecting a handoff pattern that network selection system 202 executes in some embodiments of block 312. In a decision block 802 of method 800, network selection system 202 determines whether speed of movement of user equipment device 104, as represented by speed data 206, is greater than or equal to a first handoff pattern threshold. In some embodiments, the first handoff pattern threshold delineates a fast walking speed from a running speed. If the result of decision block 802 is no, method proceeds to a block 804 where network selection system 202 selects handoff pattern 500 of FIG. 5, thereby causing user equipment device 104 to connect to every community Wi-Fi wireless access point 116 along its path of movement 122. If the result of decision block 802 is yes, method 800 proceeds to a decision block 806 where network selection system 202 determines whether speed of movement of user equipment device 104, as represented by speed data 206, is greater than or equal to a second handoff pattern threshold. In some embodiments, the second handoff pattern threshold delineates a running speed from a biking speed. If the result of decision block 806 is no, method proceeds to a block 808 where network selection system 202 selects handoff pattern 600 of FIG. 6, thereby causing user equipment device 104 to connect to every other community Wi-Fi wireless access point 116 along its path of movement 122. If the result of decision block 806 is yes, method 800 proceeds to a block 810 where network selection system 202 selects handoff pattern 700 of FIG. 7, thereby causing user equipment device 104 to connect to every third community Wi-Fi wireless access point 116 along its path of movement 122. Method 800 could be modified to support fewer possible handoff patterns, or method 800 could be modified to support additional possible handoff patterns.

Referring again to FIG. 3, if the result of decision block 314 is no, speed of movement of user equipment device 104 is classified as low, and method 300 proceeds from decision block 310 to a block 314 to where network selection system 202 selects community Wi-Fi wireless communication network 106 for use by user equipment device 104 for data transmission. It is typically advantageous for user equipment device 104 to use community Wi-Fi wireless communication network 106 instead of cellular wireless communication network 108 when user equipment device 104's speed of movement is classified as low because (i) community Wi-Fi wireless communication network 106 is typically capable of adequately serving using equipment device 104 when it is moving at a low speed and (ii) community Wi-Fi wireless communication network 106 typically has a lower use cost than cellular wireless communication network 108. In one example of block 308, network selection system 202 generates selection data 208 identifying community Wi-Fi wireless communication network 106 as the wireless communication network selected for use by user equipment device 104, in response to the result of decision block 310 being yes.

Each of blocks 308, 312, and 314 proceeds to a block 316 where network selection system 202 implements the network selection by causing user equipment device 104 to use the selected wireless communication network for data transmission. Network selection system 202 implements the network selection, for example, by (i) generating a message instructing user equipment device 104 to use a network connection associated with the wireless communication network identified by selection data 208 and/or (ii) generating a message instructing user equipment device 104 to connect to the wireless communications network identified by selection data 208. Network selection system 202 also implements a handoff pattern selected in the block 312, if applicable. For example, if network selection system 202 selects handoff pattern 600 in block 312, network selection system 202 generates, in block 316, a message instructing user equipment device 104 to connect to every other community Wi-Fi wireless access point 116 along its path of movement 122. User equipment device 104 may be connected to both of community Wi-Fi wireless communication network 106 and cellular wireless communication network 108 even though it only uses one of these wireless communication network for data transmission. For example, user equipment device 104 may remain connected to cellular wireless communication network 108 even if network selection system 202 selects community Wi-Fi wireless communication network 106 and user equipment device 104 accordingly uses community Wi-Fi wireless communication network 106 for data transmission. As another example, user equipment device 104 may remain connected to community Wi-Fi wireless communication network 106 for data transmission even if network selection system 202 selects cellular wireless communication network 108 and user equipment device 104 accordingly uses cellular wireless communication network 108 for data transmission.

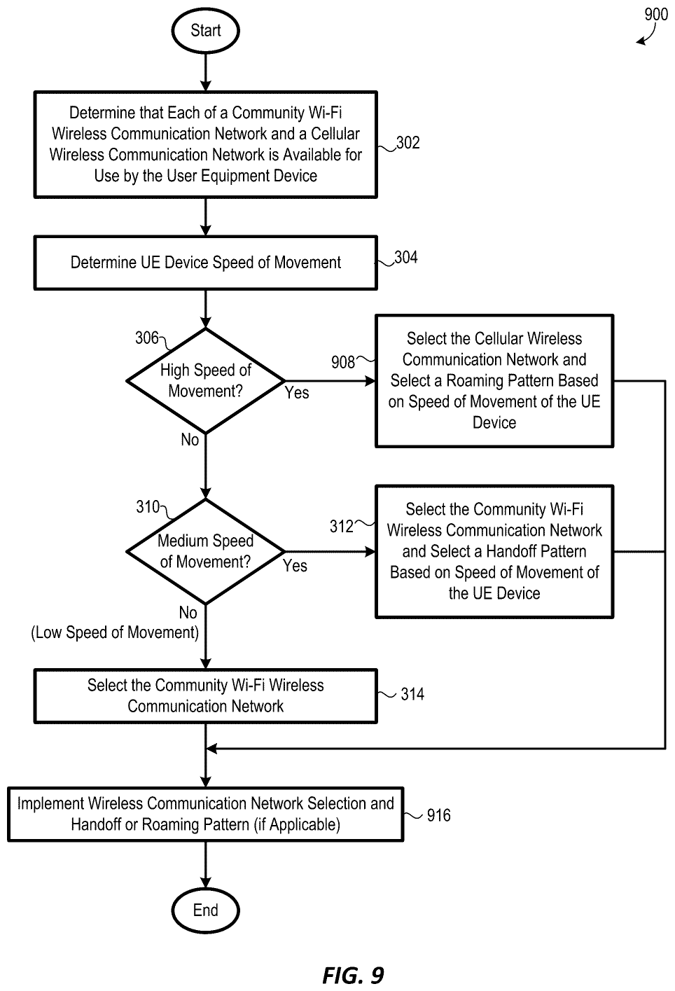

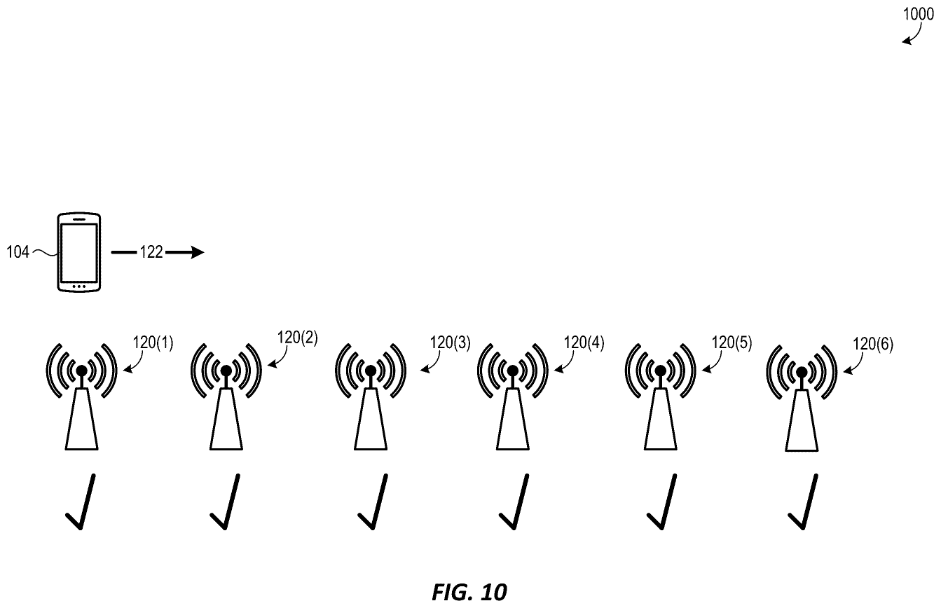

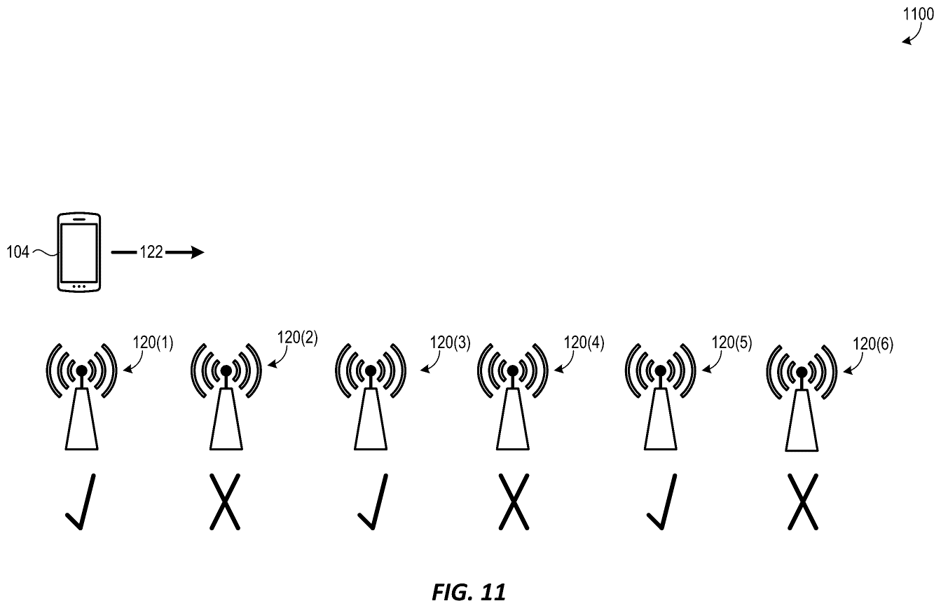

FIG. 9 is a flowchart of a method 900 for selecting a wireless communication network for use by a moving user equipment device, which is another embodiment of the new methods disclosed herein. Method 900 is like method 300 of FIG. 3 except that (i) block 308 is replaced with a block 908 and (ii) block 316 is replaced with a block 916. Block 908 is like block 308 except that block 908 further includes the step of selecting a roaming pattern of user equipment device 104 based on speed of movement 122 of user equipment device 104, as represented by speed data 206, to help minimize unnecessary roaming of user equipment device 104 between cellular wireless base stations 120. Block 916 is like block 316 except that block 916 further incudes network selection system 202 implementing a roaming pattern, if applicable. A roaming pattern species which cellular wireless base stations 120 that user equipment device 104 connects to along its path of movement 122. FIGS. 10 and 11, discussed below, illustrate a couple of example roaming patterns that network selection system 202 could select block 908. However, it is understood that network selection system 202 could select other roaming patterns in block 908. Additionally, while FIGS. 10 and 11 illustrate an embodiment where there are six cellular wireless base stations 120, it is understood that the quantity of cellular wireless base stations 120 may vary.

FIG. 10 is a schematic diagram illustrating a roaming pattern 1000 where user equipment device 104 connects to every cellular wireless base station 120 along its path of movement 122. Cellular wireless base stations 120 that user equipment device 104 connects to are labeled with a check mark, and user equipment device 104 accordingly connects to cellular wireless base stations 120(1), 120(2), 120(3), 120(4), 120(5), and 120(6) along its path of movement 122, in roaming pattern 1000.

FIG. 11 is a schematic diagram illustrating a roaming pattern 1100 where user equipment device 104 connects to every other cellular wireless base station 120 along its path of movement 122. Cellular wireless base stations 120 that user equipment device 104 connects to are labeled with a check mark while cellular wireless base stations 120 that user equipment device 104 does not connect to are labeled with the letter “X.” Accordingly, user equipment device 104 connects to cellular wireless base stations 120(1), 120(3), and 120(5) along its path of movement 122, and user equipment device 104 does not connect to cellular wireless base stations 120(2), 120(4), and 120(6) along its path of movement 122, in roaming pattern 1100.

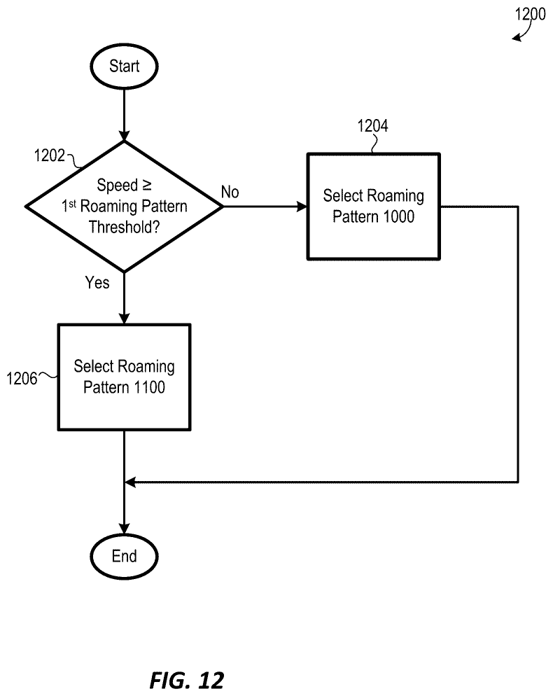

Referring again to FIG. 9, in some embodiments, network selection system 202 selects a roaming pattern such that quantity of cellular wireless base stations 120 that user equipment device 104 connects to decreases with increasing speed of movement 122 of user equipment device 104. For example, FIG. 12 is a flow chart of a method 1200 for selecting a roaming pattern that network selection system 202 executes in some embodiments of block 908. In a decision block 1202 of method 1200, network selection system 202 determines whether speed of movement of user equipment device 104, as represented by speed data 206, is greater than or equal to a first roaming pattern threshold. In some embodiments, the first roaming pattern threshold delineates a slow driving speed from a fast driving speed. If the result of decision block 1202 is no, method proceeds to a block 1204 where network selection system 202 selects roaming pattern 1000 of FIG. 10, thereby causing user equipment device 104 to connect to every cellular wireless base station 120 along its path of movement 122. If the result of decision block 1202 is yes, method 1200 proceeds to a block 1206 where network selection system 202 selects roaming pattern 1100 of FIG. 11, thereby causing user equipment device 104 to connect to every other cellular wireless base station 120 along its path of movement 122. Method 1200 could be modified to support fewer possible roaming patterns, or method 1200 could be modified to support additional possible roaming patterns.

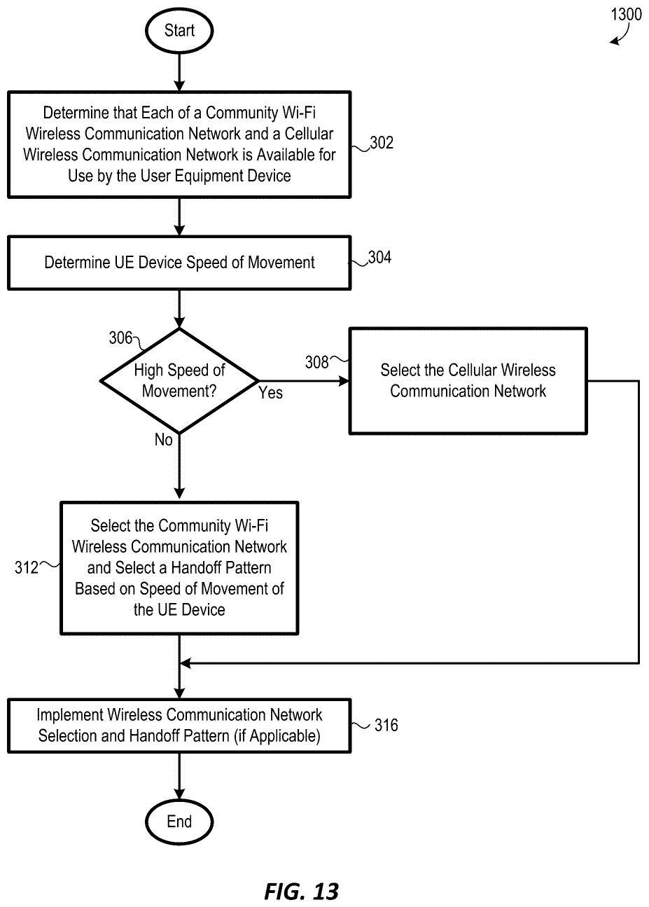

Referring again to FIG. 3, method 300 could be modified to implement only a single speed classification step or to implement one or more additional speed classification steps. For example, FIG. 13 is a flow chart of a method 300 for selecting a wireless communication network for use by a moving user equipment device that implements only a single classification step. Method 2300 is like method 1300 except that method 1300 omits decision block 310 and block 314. Accordingly, if the result of decision block 306 is yes, method 306 proceeds directly to block 312. Network selection system 202 performs blocks 302, 304, 306, 308, 312, and 316 in method 1300 in the manner discussed above with respect to method 300 of FIG. 3.

Methods 300, 900, and 1300 of FIGS. 3, 9, and 13, respectively, could be modified so that network selection system 202 further considers geographic data 210, e.g., direction of movement of user equipment device 104 and/or presence of geographic features in the vicinity of user equipment device 104, when (i) selecting a wireless communication network for use by user equipment device 104, (ii) selecting a handoff pattern, and/or (iii) selecting a roaming pattern. For example, in certain alternate embodiments of methods 300, 900, and 1300, network selection system 202 determines a predicted future location of user equipment device 104, such as based on speed data 206 and geographic data 210 (e.g., direction of movement of user equipment device 104 and/or presence of geographic features, such as sidewalks, roads, bicycle paths, or the like, in the vicinity of user equipment device 104), and limits selection of a wireless communication network to wireless communication networks that are capable of serving user equipment device 104 at its predicted future location.

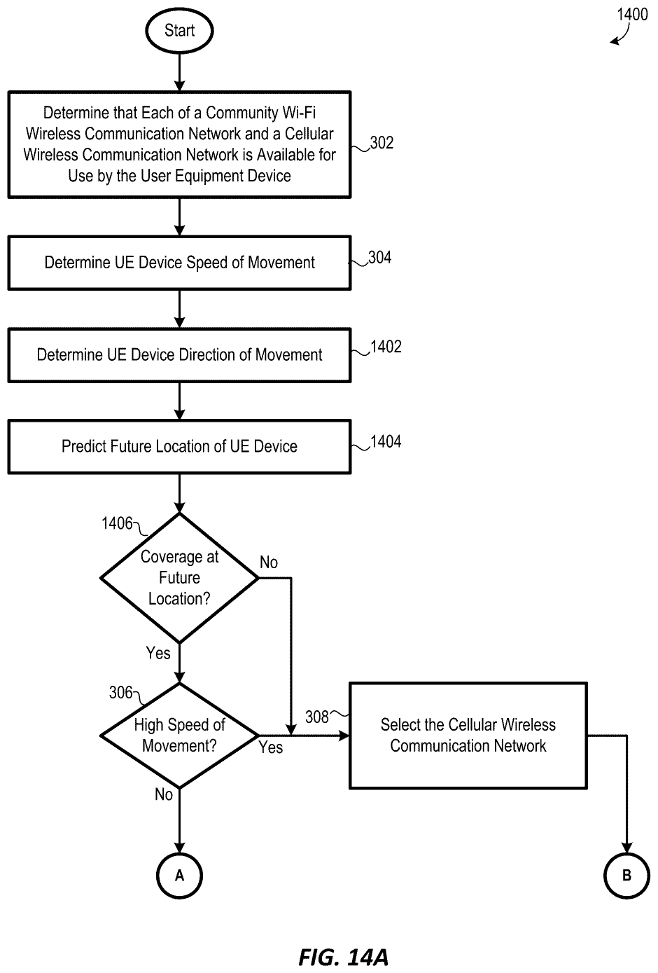

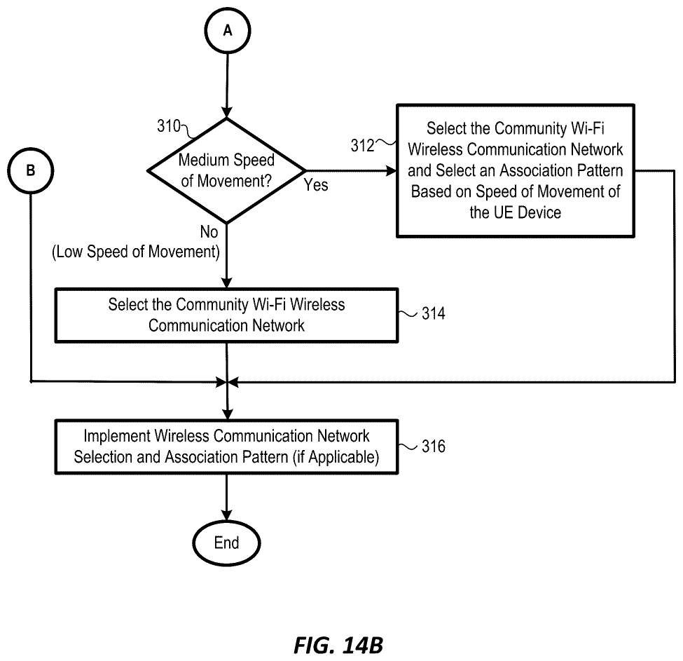

For example, FIGS. 14A and 14B are collectively a flow chart of a method 1400 for selecting a wireless communication network for use by a moving user equipment device, which is another embodiment of the new methods disclosed herein. Method 1400 is similar to method 300 of FIG. 3 except that method 1400 further considers geographic data 210 when selecting a wireless communication network for use by user equipment device 104. Method 1400 includes a block 1402, a block 1404, and a decision block 1406, in addition to the blocks of method 300. Block 1402, block 1404, and decision block 1406 are inserted between (i) block 304 and (ii) blocks 306 and block 308, in method 1400. Specifically, method 1400 executes blocks 302 and 304 as discussed above with respect to method 300, except that method 1400 proceeds from block 304 to block 1402. In block 1402, network selection system 202 determines a direction of movement of user equipment device 104. In one example of block 1402, network selection system 202 determines from geographic data 210 that user equipment device 104 is moving in a southern direction.

Method 1400 proceeds from block 1402 to a block 1404 where network selection system 202 predicts a future location of user equipment device 104. In one example of block 1404, network selection system 202 uses artificial intelligence to predict the future location of user equipment device 104 at least partially based on speed data 206, direction of movement data included geographic data 210, and known geographic features of communication environment 100 identified by geographic data 210, e.g., presence of road, sidewalk or bicycle path in the vicinity of user equipment device 104. Method 1400 proceeds from block 1404 to a decision block 1406 where network selection system 202 determines whether community Wi-Fi wireless communication network 106 provides coverage at the predicted future location of user equipment device 104. In one example of decision block 1406, network selection system 202 accesses a network coverage database to determine whether community Wi-Fi wireless communication network 106 provides coverage at the predicted future location of user equipment device 104. If the result of decision block 1406 is yes, method proceeds to block 306, and if the result of decision block 1406 is no, method proceeds to block 308. Blocks 306, 308, 310, 312, 314, and 316 are executed in method 1400 in the same manner as discussed above with respect to method 300.

Accordingly, method 1400 prevents network selection system 202 from selecting community Wi-Fi wireless communication network 106 if community Wi-Fi wireless communication network 106 does not provide coverage at a predicted future location of user equipment device 104. It is understood, though, that methods 300, 900, and 1300 could be modified to consider geographic data 210 in other manners, or in additional manners, when selecting a wireless communication network for use by user equipment device 104.

Additionally, any of methods 300, 900, 1300, and 1400 could be modified to use geographic data 210 when selecting a handoff pattern or a roaming pattern, for example, by (i) determining a predicted path of movement 122 of user equipment device 104 and (ii) identifying community Wi-Fi wireless access points 116 and/or cellular wireless base stations 120 along the predicted path of movement for inclusion in a handoff pattern or a roaming pattern. Additionally, any of methods 300, 900, 1300, and 1400 could be modified to use geographic data 210 when selecting a handoff pattern or a roaming pattern, for example, by (i) using geographic data 210 to determine a predicted speed of movement of user equipment device 104 based on presence of one or more geographic features in a vicinity of user equipment device 104 and direction of movement of user equipment device 104 and (ii) select a handoff pattern or a roaming pattern that is appropriate for the predicted speed of movement. For example, assume that geographic data 210 indicates user equipment device 104 is in the vicinity of a sidewalk. In this example, network selection system 202 could be configured to (i) predict that user equipment device 104 is moving at a walking speed due to user equipment device 104 being in the vicinity of the sidewalk and (ii) select a handoff pattern or a roaming pattern that is appropriate for a walking speed of movement. As another example, assume that geographic data 210 indicates user equipment device 104 is in the vicinity of a bicycle path. In this example, network selection system 202 could be configured to (i) predict that user equipment device 104 is moving at a biking speed due to user equipment device 104 being in the vicinity of the bicycle path and (ii) select a handoff pattern or a roaming pattern that is appropriate for a biking speed of movement.

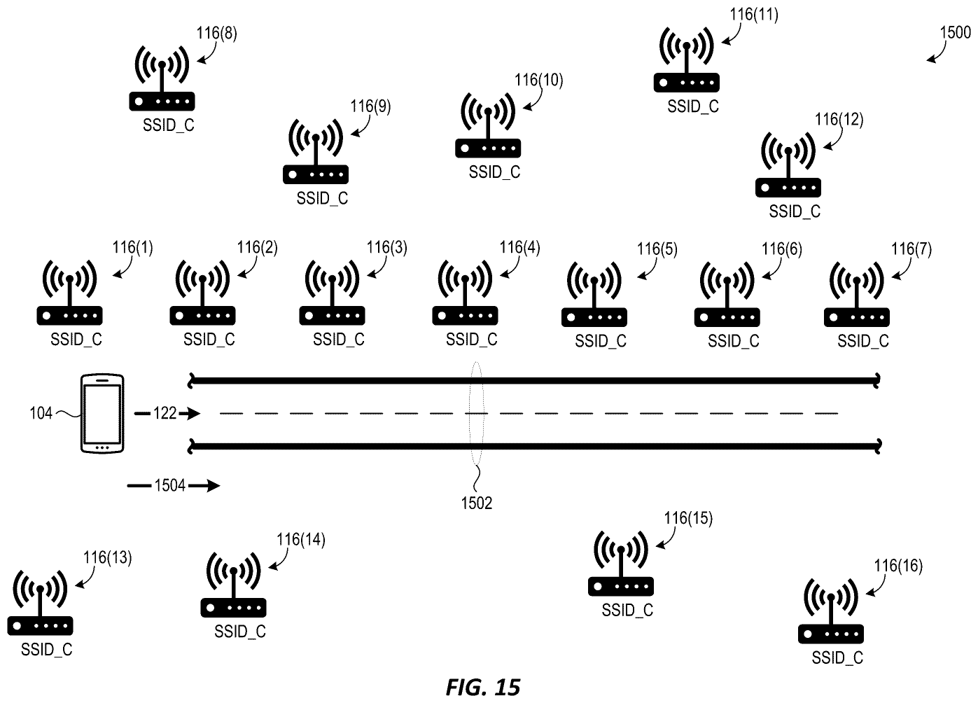

As one example of how network selection system 202 could use geographic data 210 when selecting a handoff pattern, consider FIG. 15, which is a schematic diagram of a communication environment 1500. Communication environment 1500 is one embodiment of communication environment 100 including sixteen community Wi-Fi wireless access points 116. While only community Wi-Fi wireless access points 116 and user equipment device 104 are shown in FIG. 15 for illustrative clarity, it is understood that the other elements of communication environment 100 are present in communication environment 1500. Communication environment 1500 further includes a bicycle path 1502. Assume that geographic data 210 indicates (i) geographic locations of community Wi-Fi wireless access points 116, (ii) presence of bicycle path 1502 in the vicinity of user equipment device 104, and (iii) that user equipment device 104 is moving 122 in a direction 1504 parallel to bicycle path 1502. In this scenario, particular embodiments of network selection system 202 may (i) determine from the aforementioned geographic data 210 that user equipment device 104 is likely moving along bicycle path 1502, (ii) select community Wi-Fi wireless access points 116 along bicycle path 1502, i.e., community Wi-Fi wireless access points 116(1)-116(7), for inclusion in a handoff pattern, and (iii) exclude community Wi-Fi wireless access points 116 that are not along bicycle path 1502, i.e., community Wi-Fi wireless access points 116(8)-116(16), from the handoff pattern. In certain embodiments, network selection system 202 may subsequently select a handoff pattern for community Wi-Fi wireless access points 116(1)-116(7) included in the handoff pattern based on speed of movement of user equipment device 104, such as using a method similar to method 800.

Alternately, network selection system 202 could be configured to predict a speed of movement 122 of user equipment device 104 and select a handoff pattern based on the predicted speed of movement. For example, network selection system 202 could be configured to (i) predict that user equipment device 104 is moving at a biking speed in response to geographic data 210 indicating that user equipment device 104 is moving along bicycle path 1502, and (ii) select a handoff pattern that is appropriate for user equipment device 104 moving at a bicycle speed, such as handoff pattern 700 of FIG. 7.

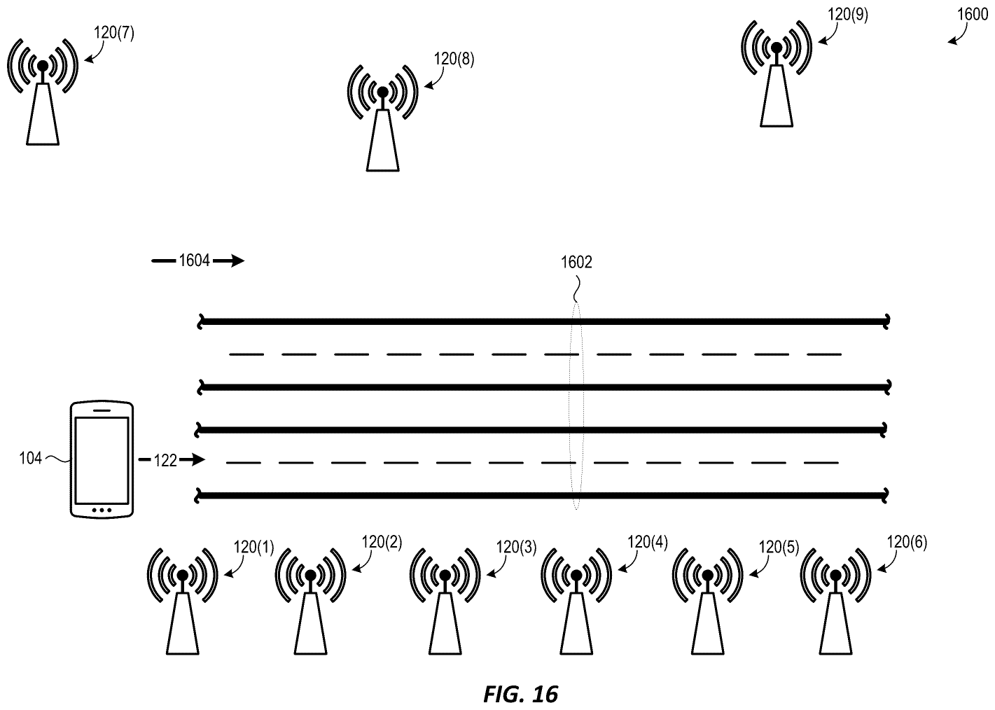

As one example of how network selection system 202 could use geographic data 210 when selecting a roaming pattern, consider FIG. 16, which is a schematic diagram of a communication environment 1600. Communication environment 1600 is one embodiment of communication environment 100 including nine cellular wireless base stations 120. While only cellular wireless base stations 120 and user equipment device 104 are shown in FIG. 16 for illustrative clarity, it is understood that the other elements of communication environment 100 are present in communication environment 1600. Communication environment 1600 further includes a road (divided highway) 1602. Assume that geographic data 210 indicates (i) geographic locations of cellular wireless base stations 120, (ii) presence of road 1602 in the vicinity of user equipment device 104, and (iii) that user equipment device 104 is moving 122 in a direction 1604 that is parallel to road 1602. In this scenario, particular embodiments of network selection system 202 may (i) determine from the aforementioned geographic data 210 that user equipment device 104 is likely moving along road 1602, (ii) select cellular wireless base stations 120 along road 1602, i.e., cellular wireless base stations 120(1)-120(6) for inclusion in a roaming pattern, and (iii) exclude cellular wireless base stations 120 that are not along road 1602, i.e., cellular wireless base stations 120(7)-120(9) from the roaming pattern. In certain embodiments, network selection system 202 may subsequently select a roaming pattern for cellular wireless base stations 120(1)-120(6) included in the roaming pattern based on speed of movement of user equipment device 104, such as using a method similar to method 1200.

Alternately, network selection system 202 could be configured to predict a speed of movement 122 of user equipment device 104 and select a roaming pattern based on the predicted speed of movement. For example, network selection system 202 could be configured to (i) predict that user equipment device 104 is moving at a driving speed in response to geographic data 210 indicating that user equipment device 104 is moving along road 1602, and (ii) select a handoff pattern that is appropriate for user equipment device 104 moving at a driving speed, such as roaming pattern 1100 of FIG. 11.

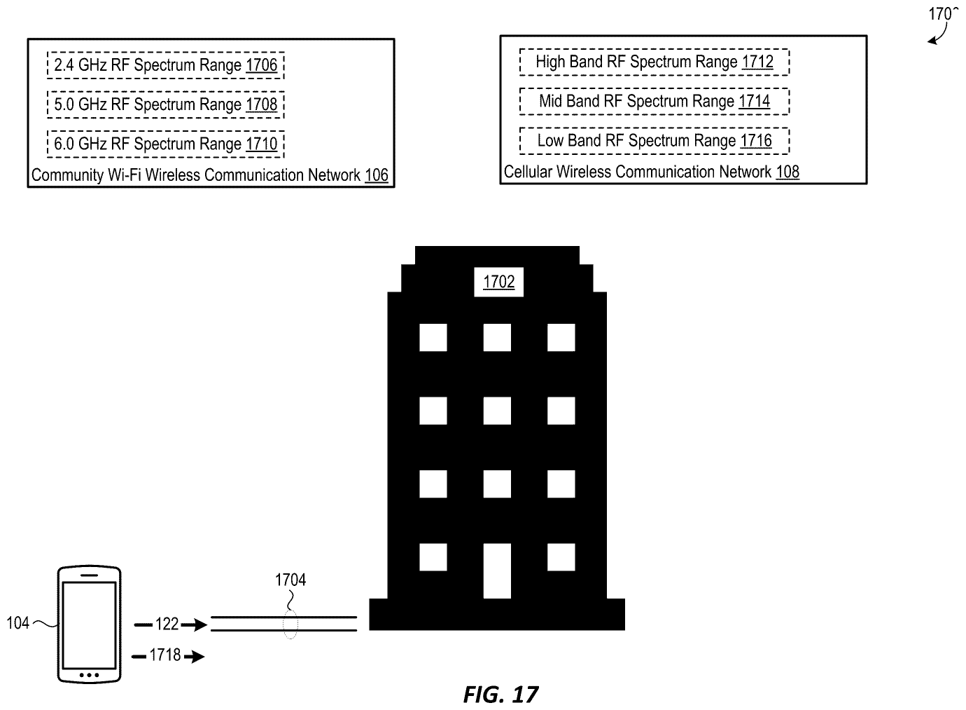

Any of methods 300, 900, 1300, and 1400 could be modified to select radio frequency spectrum used by a selected wireless communication network when wirelessly communicating with user equipment device 104, as a function of speed of movement of the user equipment device and/or as a function of geographic data 210 (e.g., direction of movement and/or presence of geographic features). For example, FIG. 17 is a schematic diagram of a communication environment 1700 including a building 1702 and a walkway 1704, where walkway 1704 leads to building 1702. Each of community Wi-Fi wireless communication network 106 and cellular wireless communication network 108 is symbolically shown as respective box in FIG. 17, and details of community Wi-Fi wireless communication network 106 and cellular wireless communication network 108 are accordingly not shown. Premises 102, private Wi-Fi wireless communication networks 110, and private Wi-Fi wireless access points 112 are also not shown, but it is understood that these elements are included in communication environment 1600.

Community Wi-Fi wireless communication network 106 is illustrated as supporting the following three radio frequency (RF) spectrum ranges for wirelessly communicating with user equipment device 104: (i) a 2.4 GHz spectrum frequency range 1706, (ii) a 5.0 GHz spectrum frequency range 1708, and (iii) a 6.0 GHz spectrum frequency range 1710. Additionally, cellular wireless communication network 108 is illustrated as supporting the following three radio frequency spectrum ranges for wirelessly communicating with user equipment device 104: (i) a high band radio frequency spectrum range 1712, (ii) a mid band radio frequency spectrum range 1714, and (iii) a low band radio frequency spectrum range 1716. However, it should be understood community Wi-Fi wireless communication network 106 and cellular wireless communication network 108 could support radio frequency ranges other than, or addition to, the radio frequency ranges illustrated in FIG. 17. High band radio frequency spectrum range 1712 includes, for example, radio frequency spectrum in ranges above 6 GHz, such as in a 28 GHz spectrum range and/or a 39 GHz spectrum frequency range. Mid band radio frequency spectrum range 1714 includes, for example, radio frequency spectrum ranges below 6 GHz, such as in a 2.5 GHz spectrum frequency range, a 3.45 GHz spectrum frequency range, and/or a 3.7 GHz spectrum frequency range. Low band radio frequency spectrum range 1716 includes radio frequency spectrum ranges below mid band radio frequency spectrum range 1714, such as in a 600 megahertz (MHz) spectrum frequency range, a 700 MHz spectrum frequency range, a 850 MHz spectrum frequency range, a 1,700 MHz spectrum frequency range, a 1,900 MHz spectrum frequency range, and/or a 2100 MHz spectrum frequency range. However, it is understood that high band radio frequency spectrum range 1712, mid band radio frequency spectrum range 1714, and low band radio frequency spectrum range 1716 are not limited to aforementioned example frequency spectrum ranges.

In particular embodiments of communication environment 1700, network selection system 202 is configured to select radio frequency spectrum for use by community Wi-Fi wireless communication network 106 or cellular wireless communication network 108 for wirelessly communicating with user equipment device 104 at least partially as a function of speed data 206 and/or geographic data 210. For example, assume network selection system 202 determines from speed data 206 that user equipment device 104 is moving at a walking speed. Additionally, assume that network selection system 202 determines from geographic data 210 that communication environment 1700 includes building 1702 and walkway 1704, as well as that user equipment device 104 is moving in a direction 1718 parallel with walkway 1704 and toward building 1702. Using the aforementioned information, such as with in conjunction with artificial intelligence, particular embodiments of network selection system 202 may predict a future location of user equipment device 104 that is within building 1702. Network selection system 202 may then select a radio frequency spectrum range that is known to provide adequate coverage within building 1702. For example, in scenarios where network selection system 202 selects community Wi-Fi wireless communication network 106 for use by user equipment device 104, network selection system 202 may select 2.4 GHz spectrum range 1706 for use by community Wi-Fi wireless communication network 106 for wireless communication with user equipment device 104 because 2.4 GHz frequency range 1706 is better able to penetrate building 1702 than the other two radio frequency spectrum ranges supported by community Wi-Fi wireless communication network 106. As another example, in scenarios where network selection system 202 selects cellular wireless communication network 108 for use by user equipment device 104, network selection system 202 may select low band radio frequency spectrum range 1716 for use by cellular wireless communication network 108 when wirelessly communicating with user equipment device 104 because low band radio frequency spectrum range 1716 is better able to penetrate building 1702 than the other two radio frequency spectrum ranges supported by cellular wireless communication network 108.

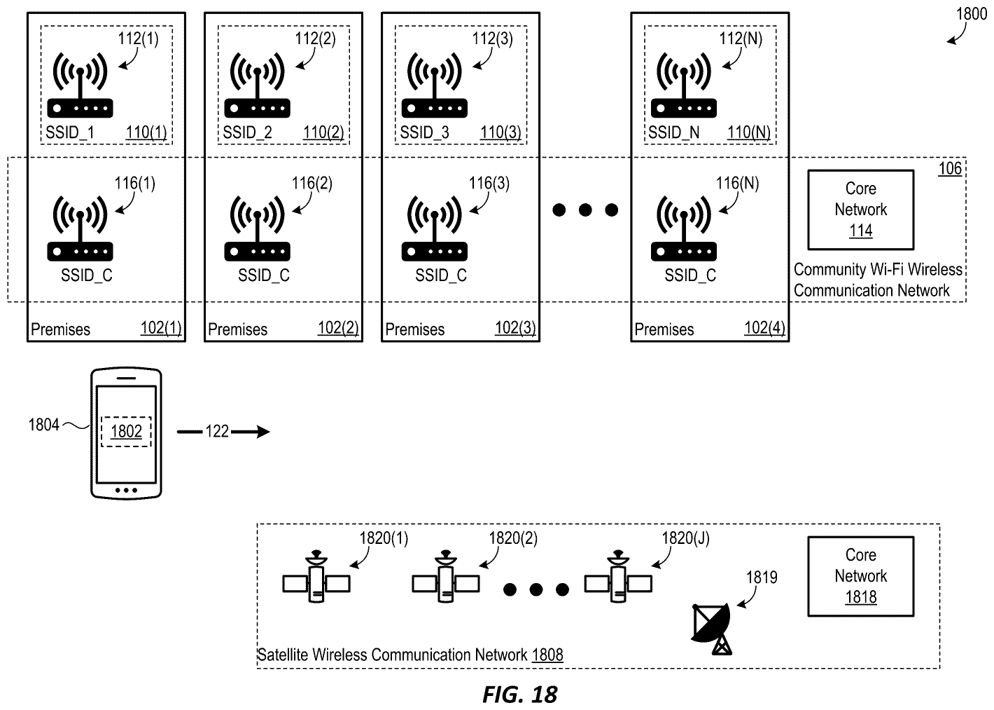

Referring again to FIGS. 1 and 2, network selection system 202 could be modified to select from one or more wireless communication networks other than, or in addition to, community Wi-Fi wireless communication network 106 and cellular wireless communication network 108 for use by a user equipment device. For example, FIG. 18 is a schematic diagram of a communication environment 1800, which is an alternate embodiment of communication environment 100 where (i) cellular wireless communication network 108 is replaced with a satellite wireless communication network 1808 and (ii) user equipment device 104 is replaced with a user equipment device 1804. Satellite wireless communication network 1808 includes a core network 1818, J satellites 1820, and a ground station 1819, where J is an integer greater than one. Satellites 1820 are, for example, VLEO satellites, LEO satellites, MEO satellites, or GEO satellites. Each satellite 1820 is configured to relay wireless communication signals between ground station 1819 and user equipment devices, such as user equipment device 1804. Core network 1818 controls, for example, user plane functions and control plane functions of satellite wireless communication network 1808.

User equipment device 1804 is like user equipment device 104 except that user equipment device 1804 includes a network selection system 1802 in place of network selection system 202. Network selection system 1802 operates in the same manner as network selection system 202 except that network selection system 1802 is configured to select one of community Wi-Fi wireless communication network 106 and satellite wireless communication network 1808 for use by user equipment device 1804 for data transmission. For example, in certain embodiments, network selection system 1802 is configured to execute one or more of methods 300, 900, 1300, and 1400 that are modified by (i) replacing cellular wireless communication network 108 with satellite wireless communication network 1808 and (ii) replacing user equipment device 104 with user equipment device 1804. While not shown in FIG. 18, it is understood that user equipment device 1804 stores data analogous to available networks data 204, speed data 206, and selection data 208 of FIG. 2. Additionally, in certain embodiments, user equipment device 1804 stores one or more of data analogous to geographic data 210 and data analogous to spectrum data 212.

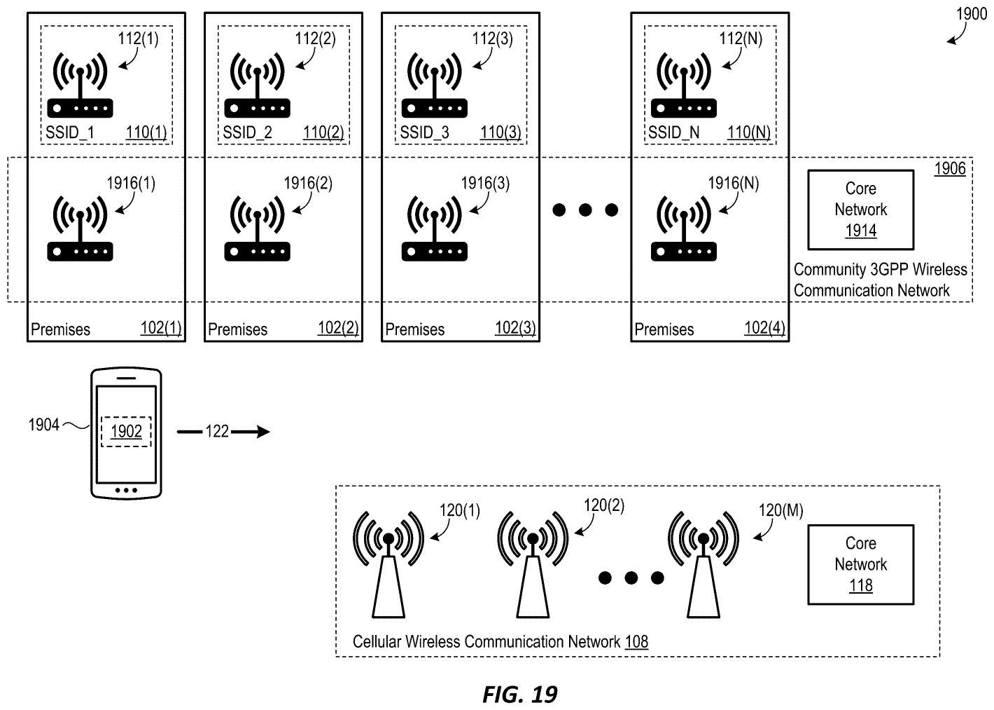

FIG. 19 is a schematic diagram of a communication environment 1900, which is an alternate embodiment of communication environment 100 where (i) community Wi-Fi wireless communication network 106 is replaced with a community 3GPP wireless communication network 1906 and (ii) user equipment device 104 is replaced with a user equipment device 1904. Community 3GPP wireless communication network 1906 includes a core network 1914 and a plurality of community 3GPP wireless access points 1916. While FIG. 19 illustrates each premises 102 including one community 3GPP wireless access point 1916, community 3GPP wireless access points 1916 could be distributed among premises 102 in a different manner, as long as community 3GPP wireless access points 1916 are distributed among multiple premises 102. For example, some premises 102 could include two or more community 3GPP wireless access points 1916 while some other premises 102 might not include any community 3GPP wireless access points 1916. Core network 1914 at least partially controls operation of community 3GPP wireless access points 1916, such as to coordinate handoff of a user equipment device between two community 3GPP wireless access points 1916 and/or to coordinate radio frequency spectrum use among community 3GPP wireless access points 1916. While core network 1914 is illustrated as being a discrete element, core network 1914 may be partially or fully combined with another element. Additionally, in some alternate embodiments, core network 1914 is omitted and functionality of core network 1914 is instead implemented by one or more community 3GPP wireless access points 1916.

Although private Wi-Fi wireless access points 112 and community 3GPP wireless access points 1916 are illustrated as being separate elements, in certain embodiments, a private Wi-Fi wireless access point 112 and a community 3GPP wireless access point 1916 of a given premises 102 may share some or more elements. For example, in some embodiments, private Wi-Fi wireless access point 112(1) and community 3GPP wireless access point 1916(1) are part of a common premises gateway (not shown) in premises 102(1). In these embodiments, private Wi-Fi wireless access point 112(1) and community 3GPP wireless access point 1916(1) may share one or more elements. For example, private Wi-Fi wireless access point 112(1) and community 3GPP wireless access point 1916(1) may share an access network termination device (e.g., a modem or an optical network termination), an antenna, and/or transceiver, such as by using a time division multiplexing technique and/or a frequency division multiplexing technique. Private Wi-Fi wireless access points 112 and community 3GPP wireless access points 116 of other premises 102 could be combined in a similar manner

User equipment device 1904 is like user equipment device 104 except that user equipment device 1904 includes a network selection system 1902 in place of network selection system 202. Network selection system 1902 operates in the same manner as network selection system 202 except that network selection system 1902 is configured to select one of community 3GPP wireless communication network 1906 and cellular wireless communication network 108 for use by user equipment device 1904 for data transmission. For example, in certain embodiments, network selection system 1902 is configured to execute one or more of methods 300, 900, 1300, and 1400 that are modified by (i) replacing community Wi-Fi wireless communication network 106 with community 3GPP wireless communication network 1906 and (ii) replacing user equipment device 104 with user equipment device 1904. While not shown in FIG. 19, it is understood that user equipment device 1904 stores data analogous to available networks data 204, speed data 206, and selection data 208 of FIG. 2. Additionally, in certain embodiments, user equipment device 1904 stores one or more of data analogous to geographic data 210 and data analogous to spectrum data 212.

### Combinations of Features

Features described above may be combined in various ways without departing from the scope hereof. The following examples illustrate some possible combinations.
(A1) A method for selecting a wireless communication network for use by a user equipment device that is moving includes (1) determining that each of a community Wi-Fi wireless communication network and a cellular wireless communication network is available for use by the user equipment device, (2) determining that a speed of movement of the user equipment device does not exceed a threshold value, and (3) in response to determining that the speed of movement of the user equipment device does not exceed the threshold value, causing the user equipment device to use the community Wi-Fi wireless communication network, instead of the cellular wireless communication network, for data transmission.
(A2) The method denoted as (A1) may further include, before determining that each of the community Wi-Fi wireless communication network and the cellular wireless communication network is available for use by the user equipment device, causing the user equipment device to (i) disconnect from a private Wi-Fi wireless communication network and (ii) connect to the community Wi-Fi wireless communication network.
(A3) In any one of the methods denoted as (A1) and (A2), the user equipment device may be connected to the cellular wireless communication network while the user equipment device uses the community Wi-Fi wireless communication network for data transmission.
(A4) In any one of the methods denoted as (A1) through (A3), (1) the community Wi-Fi wireless communication network may include a plurality of community Wi-Fi wireless access points providing coverage along a path of movement of the user equipment device, and (2) the method may further include (i) selecting a handoff pattern at least partially based on the speed of movement of the user equipment device and (ii) causing the user equipment device to connect to the plurality of community Wi-Fi wireless access points along the path of movement of the user equipment device according to the handoff pattern.
(A5) In the method denoted as (A4), the handoff pattern may cause the user equipment device to (i) connect to every other community Wi-Fi wireless access point along the path of movement of the user equipment device, or (ii) connect to every third community Wi-Fi wireless access point along the path of movement of the user equipment device.
(A6) Any one of the methods denoted as (A4) and (A5) may further include selecting the handoff pattern based on one or more of (i) a direction of movement of the user equipment device and (ii) presence of one or more geographic features in a vicinity of the user equipment device.
(A7) Any one of the methods denoted as (A1) through (A6) may further include selecting, at least partially based on a direction of movement of the user equipment device, one or more radio frequency spectrum ranges used by the community Wi-Fi wireless communication network when wirelessly communicating with the user equipment device.
(B1) A method for selecting a wireless communication network for use by a user equipment device that is moving includes (1) determining that each of a community Wi-Fi wireless communication network and a cellular wireless communication network is available for use by the user equipment device, (2) determining that a speed of movement of the user equipment device is at least a threshold value, and (3) in response to determining that the speed of movement of the user equipment device is at least the threshold value, causing the user equipment device to use the cellular wireless communication network, instead of the community Wi-Fi wireless communication network, for data transmission.
(B2) The method denoted as (B1) may further include, before determining that each of the community Wi-Fi wireless communication network and the cellular wireless communication network is available for use by the user equipment device, causing the user equipment device to (i) disconnect from a private Wi-Fi wireless communication network and (ii) connect to the community Wi-Fi wireless communication network.
(B3) In any one of the methods denoted as (B1) and (B2), (1) the cellular wireless communication network may include a plurality of cellular wireless base stations providing coverage along a path of movement of the user equipment device, and (2) the method may further include (ii) selecting a roaming pattern at least partially based on the speed of movement of the user equipment device and (iii) causing the user equipment device to connect to the plurality of cellular wireless base stations along the path of movement of the user equipment device according to the roaming pattern.
(B4) In the method denoted as (B3), the roaming pattern may cause the user equipment device to (i) connect to every other cellular wireless base station along the path of movement of the user equipment device, or (ii) connect to every third cellular wireless base station along the path of movement of the user equipment device.
(B5) Either one of the methods denoted as (B3) and (B4) may further include selecting the roaming pattern based on one or more of (i) a direction of movement of the user equipment device and (ii) presence of one or more geographic features in a vicinity of the user equipment device.
(B6) Any one of the methods denoted as (B1) through (B5) may further include selecting, at least partially based on direction of movement of the user equipment device, one or more radio frequency spectrum ranges used by the cellular wireless communication network when wirelessly communicating with the user equipment device.
(C1) A method for selecting a wireless communication network for use by a user equipment device that is moving includes (a) determining that the user equipment device is connected to each of a first wireless communication network and a second wireless communication network and (b) selecting, at least partially based on speed of movement of the user equipment device, one of the first wireless communication network and the second wireless communication network for use by the user equipment device for data transmission.
(C2) In the method denoted as (C1), (1) the first wireless communication network may be one of a community Wi-Fi wireless communication network and a community Third Generation Partnership Project (3GPP) wireless communication network, and (2) the second wireless communication network may be one of a cellular wireless communication network and satellite wireless communication network.
(C3) Any one of the methods denoted as (C1) and (C2) may further include selecting the one of the first wireless communication network and the second wireless communication network for use by the user equipment device for data transmission partially based on a direction of movement of the user equipment device.
(C4) Any one of the methods denoted as (C1) through (C3) may further include selecting the one of the first wireless communication network and the second wireless communication network for use by the user equipment device for data transmission partially based presence of one or more geographic features in a vicinity of the user equipment device.
(C5) In any one of the methods denoted as (C1) through (C4), (1) the first wireless communication network may be a community Wi-Fi wireless communication network, (2) the second wireless communication network may be a cellular wireless communication network, and (3) step (b) may include selecting the cellular wireless communication network for use by the user equipment device for data transmission in response to the speed of movement of the user equipment device being classified as high speed.
(C6) In any one of the methods denoted as (C1) through (C4), (1) the first wireless communication network may be a community Wi-Fi wireless communication network, (2) the second wireless communication network may be a cellular wireless communication network, and (3) step (b) may include selecting the community Wi-Fi wireless communication network for use by the user equipment device for data transmission in response to the speed of movement of the user equipment device being classified as low speed.
(C7) In any one of the methods denoted as (C1) through (C4), (1) the first wireless communication network may be a community Wi-Fi wireless communication network, (2) the second wireless communication network may be a cellular wireless communication network, (3) step (b) may include selecting the community Wi-Fi wireless communication network for use by the user equipment device for data transmission in response to the speed of movement of the user equipment device being classified as medium speed, (4) the community Wi-Fi wireless communication network may include a plurality of community Wi-Fi wireless access points providing coverage along a path of movement of the user equipment device, and (5), the method may further include (i) selecting a handoff pattern at least partially based on the speed of movement of the user equipment device and (ii) causing the user equipment device to connect to the plurality of community Wi-Fi wireless access points along the path of movement of the user equipment device according to the handoff pattern.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A method for selecting a wireless communication network for use by a user equipment device that is moving, the method comprising:
determining that each of a community Wi-Fi wireless communication network and a cellular wireless communication network is available for use by the user equipment device;
determining that a speed of movement of the user equipment device does not exceed a threshold value; and
in response to determining that the speed of movement of the user equipment device does not exceed the threshold value, causing the user equipment device to use the community Wi-Fi wireless communication network, instead of the cellular wireless communication network, for data transmission.

2. The method of claim 1, further comprising, before determining that each of the community Wi-Fi wireless communication network and the cellular wireless communication network is available for use by the user equipment device, causing the user equipment device to (i) disconnect from a private Wi-Fi wireless communication network and (ii) connect to the community Wi-Fi wireless communication network.

3. The method of claim 1, wherein the user equipment device is connected to the cellular wireless communication network while the user equipment device uses the community Wi-Fi wireless communication network for data transmission.

4. The method of claim 1, wherein:
the community Wi-Fi wireless communication network comprises a plurality of community Wi-Fi wireless access points providing coverage along a path of movement of the user equipment device; and
the method further comprises:
selecting a handoff pattern at least partially based on the speed of movement of the user equipment device, and
causing the user equipment device to connect to the plurality of community Wi-Fi wireless access points along the path of movement of the user equipment device according to the handoff pattern.

5. The method of claim 4, wherein the handoff pattern causes the user equipment device to (i) connect to every other community Wi-Fi wireless access point along the path of movement of the user equipment device, or (ii) connect to every third community Wi-Fi wireless access point along the path of movement of the user equipment device.

6. The method of claim 4, further comprising selecting the handoff pattern based on one or more of (i) a direction of movement of the user equipment device and (ii) presence of one or more geographic features in a vicinity of the user equipment device.

7. The method of claim 1, further comprising selecting, at least partially based on a direction of movement of the user equipment device, one or more radio frequency spectrum ranges used by the community Wi-Fi wireless communication network when wirelessly communicating with the user equipment device.

8. A method for selecting a wireless communication network for use by a user equipment device that is moving, the method comprising:
determining that each of a community Wi-Fi wireless communication network and a cellular wireless communication network is available for use by the user equipment device;
determining that a speed of movement of the user equipment device is at least a threshold value; and
in response to determining that the speed of movement of the user equipment device is at least the threshold value, causing the user equipment device to use the cellular wireless communication network, instead of the community Wi-Fi wireless communication network, for data transmission.

9. The method of claim 8, further comprising, before determining that each of the community Wi-Fi wireless communication network and the cellular wireless communication network is available for use by the user equipment device, causing the user equipment device to (i) disconnect from a private Wi-Fi wireless communication network and (ii) connect to the community Wi-Fi wireless communication network.

10. The method of claim 8, wherein:
the cellular wireless communication network comprises a plurality of cellular wireless base stations providing coverage along a path of movement of the user equipment device; and
the method further comprises:
selecting a roaming pattern at least partially based on the speed of movement of the user equipment device, and
causing the user equipment device to connect to the plurality of cellular wireless base stations along the path of movement of the user equipment device according to the roaming pattern.

11. The method of claim 10, wherein the roaming pattern causes the user equipment device to (i) connect to every other cellular wireless base station along the path of movement of the user equipment device, or (ii) connect to every third cellular wireless base station along the path of movement of the user equipment device.

12. The method of claim 10, further comprising selecting the roaming pattern based on one or more of (i) a direction of movement of the user equipment device and (ii) presence of one or more geographic features in a vicinity of the user equipment device.

13. The method of claim 8, further comprising selecting, at least partially based on direction of movement of the user equipment device, one or more radio frequency spectrum ranges used by the cellular wireless communication network when wirelessly communicating with the user equipment device.

14. A method for selecting a wireless communication network for use by a user equipment device that is moving, the method comprising:
(a) determining that the user equipment device is connected to each of a first wireless communication network and a second wireless communication network; and
(b) selecting, at least partially based on speed of movement of the user equipment device, one of the first wireless communication network and the second wireless communication network for use by the user equipment device for data transmission.

15. The method of claim 14, wherein:
the first wireless communication network is one of a community Wi-Fi wireless communication network and a community Third Generation Partnership Project (3GPP) wireless communication network; and
the second wireless communication network is one of a cellular wireless communication network and satellite wireless communication network.

16. The method of claim 14, further comprising selecting the one of the first wireless communication network and the second wireless communication network for use by the user equipment device for data transmission partially based on a direction of movement of the user equipment device.

17. The method of claim 14, further comprising selecting the one of the first wireless communication network and the second wireless communication network for use by the user equipment device for data transmission partially based presence of one or more geographic features in a vicinity of the user equipment device.

18. The method of claim 14, wherein:
the first wireless communication network is a community Wi-Fi wireless communication network;
the second wireless communication network is a cellular wireless communication network; and
step (b) comprises selecting the cellular wireless communication network for use by the user equipment device for data transmission in response to the speed of movement of the user equipment device being classified as high speed.

19. The method of claim 14, wherein:
the first wireless communication network is a community Wi-Fi wireless communication network;
the second wireless communication network is a cellular wireless communication network; and
step (b) comprises selecting the community Wi-Fi wireless communication network for use by the user equipment device for data transmission in response to the speed of movement of the user equipment device being classified as low speed.

20. The method of claim 14, wherein:
the first wireless communication network is a community Wi-Fi wireless communication network;
the second wireless communication network is a cellular wireless communication network;
step (b) comprises selecting the community Wi-Fi wireless communication network for use by the user equipment device for data transmission in response to the speed of movement of the user equipment device being classified as medium speed;
the community Wi-Fi wireless communication network comprises a plurality of community Wi-Fi wireless access points providing coverage along a path of movement of the user equipment device; and
the method further comprises:
selecting a handoff pattern at least partially based on the speed of movement of the user equipment device, and
causing the user equipment device to connect to the plurality of community Wi-Fi wireless access points along the path of movement of the user equipment device according to the handoff pattern.
